(19) United States
(12) Patent Application Publication
(10) Pub. No.: US 2023/0393659 A1
(43) Pub. Date: Dec. 7, 2023

(54) TACTILE MESSAGES IN AN EXTENDED REALITY ENVIRONMENT

(71) Applicant: Meta Platforms Technologies, LLC, Menlo Park, CA (US)

(72) Inventors: Joshua Erik WALTON, Kirkland, WA (US); Nitzan BARTOV, Brooklyn, NY (US); Sarah SYKES, Kirkland, WA (US); Austin LEE, Seattle, WA (US)

(73) Assignee: Meta Platforms Technologies, LLC, Menlo Park, CA (US)

(21) Appl. No.: 18/303,644

(22) Filed: Apr. 20, 2023

Related U.S. Application Data
(60) Provisional application No. 63/365,689, filed on Jun. 1, 2022.

(51) Int. Cl. G06F 3/01; G06T 11/00; H04L 51/04; G08B 6/00; G06F 16/9532; G06F 16/9536

(52) U.S. Cl. CPC G06F 3/016; G06T 11/00; G06F 3/011; H04L 51/04; G08B 6/00; G06F 16/9532; G06F 16/9536; G06T 2200/24

(57) ABSTRACT

Techniques for sending and receiving tactile messages (e.g., haptic emojis) in an extended reality environment to facilitate touch communication between users. In one particular aspect, an extended reality system is provided having a head-mounted device with a display to display content to a first user, sensors to capture input data, processors, and memories accessible to the processors, the memories storing instructions executable by the processors to perform processing including: capturing, using the one or more sensors, the input data from the first user, extracting features from the input data that correspond to an electronic communication, identifying an emoji from a lexicon of emojis based on the extracted features, obtaining digital assets for the emoji, where the digital assets comprise a haptic signal configured with parameter information to generate patterns for haptic output, and transmitting the digital assets to a device of a second user.

### CROSS-REFERENCE TO RELATED APPLICATION

The present application is a non-provisional application of and claims the benefit and priority under 35 U.S.C. 119(e) of U.S. Provisional Application No. 63/365,689, filed Jun. 1, 2022, the entire contents of which is incorporated herein by reference for all purposes.

### FIELD

The present disclosure relates generally to haptic communication in an extended reality environment, and more particularly, to techniques for sending and receiving tactile messages (e.g., haptic emojis) in an extended reality environment to facilitate touch communication between users.

### BACKGROUND

Extended reality is a form of reality that has been adjusted in some manner before presentation to a user, which may include, e.g., a virtual reality (VR), an augmented reality (AR), a mixed reality (MR), a hybrid reality, or some combination and/or derivatives thereof. Extended reality content may include completely generated virtual content or generated virtual content combined with physical content (e.g., physical or real-world objects). The extended reality content may include digital images or animation, text, video, audio, haptic feedback, or some combination thereof, and any of which may be presented in a single channel or in multiple channels (such as stereo video that produces a three-dimensional effect to the viewer). Extended reality may be associated with applications, products, accessories, services, or some combination thereof, that are, e.g., used to create content in an extended reality and/or used in (e.g., perform activities in) an extended reality. The extended reality system that provides such content may be implemented on various platforms, including a head-mounted display (HMD) connected to a host computer system, a standalone HMD, a mobile device or computing system, or any other hardware platform capable of providing extended reality content to one or more viewers.

Extended reality systems have enormous potential in the manner in which content is provided to users. However, at times extended reality can make users feel socially disconnected or isolated from other users. For example, in a real world social setting users communicate content and emotion via visual (e.g., via emotions on ones face or hand gestures), audible (e.g., via voice or synthetic sounds), or tactile means (e.g., via touch). In contrast, in social communities where users are remote from one another (at different locations inside and/or outside of extended reality) users typically communicate content to one another via some form of text message, and one in five of those text messages contain a visual and/or audible emoji to allow the users to express their emotions. From a social communication standpoint, visual and/or audible emojis fall short on expressive emoting capabilities because they lack the third sense, touch. In many social communities, touch is an important social and emotional cue that help users communicate and express themselves. Accordingly, creating a new social communication platform for expression that is not just visual or auditory can add to user expressiveness and a greater sense of community or less of a feeling of isolation.

### BRIEF SUMMARY

Techniques disclosed herein relate generally to haptic communication in an extended reality environment. More specifically and without limitation, techniques disclosed herein relate to sending and receiving tactile messages (e.g., haptic emojis) in an extended reality environment to facilitate touch communication between users. Haptic emojis or reactions are tactile messages that can be sent and received throughout the day with a wearable device (e.g., haptic glove or wrist band). Each haptic emoji or reaction may be accompanied by audio and/or visual components to help train a user on the haptic signals. The tactile messages can be sent through traditional user interfaces, haptic first interfaces, or more expressive gestures such as a hand wave, where in this example the recipient may feel a haptic pattern to mimic a wave motion.

In various embodiments, an extended reality system is provided that includes: a head-mounted device comprising a display to display content to a first user, one or more sensors to capture input data including images of a visual field of the first user; one or more processors, and one or more memories accessible to the one or more processors, the one or more memories storing a plurality of instructions executable by the one or more processors, the plurality of instructions comprising instructions that when executed by the one or more processors cause the one or more processors to perform processing comprising: capturing, using the one or more sensors, the input data from the first user, extracting features from the input data that correspond to an electronic communication, identifying an emoji from a lexicon of emojis based on the extracted features, obtaining digital assets for the emoji, wherein the digital assets comprise a haptic signal configured with parameter information to generate patterns for haptic output, and transmitting the digital assets to a device of a second user.

In some embodiments, the extracting the features comprises: determining characteristics of the input data, and identifying patterns within the input data that correspond to a key or attributes of electronic communication based on the characteristics, the key or attributes being the extracted features, and the identifying the emoji comprises: constructing a query using the extracted features as parameters of the query, and executing the query on the lexicon of emojis.

In some embodiments, the haptic signal is configured with the parameter information for interval, pitch, and amplitude to generate the patterns for the haptic output.

In some embodiments, the digital assets further comprise an image or video asset, an audio asset, or both.

In some embodiments, the processing further comprises obtaining additional information based on the emoji or the haptic signal, the additional information includes a text description of the haptic output conveyed by the haptic signal, an audio component corresponding to the haptic signal, an image component corresponding to the haptic signal, or a combination thereof, and transmitting the additional information to the device of the second user.

In various embodiments, an extended reality system is provided that includes: a head-mounted device comprising a display to display content to a first user, one or more sensors to capture input data including images of a visual field of the first user, one or more processors, and one or more memories accessible to the one or more processors, the one or more memories storing a plurality of instructions executable by the one or more processors, the plurality of instructions comprising instructions that when executed by the one or more processors cause the one or more processors to perform processing comprising: capturing, using the one or more sensors, the input data from the first user, predicting a haptic emoji or a haptic signal based on the input data and model parameters learned from historical input data and context data, and transmitting the haptic signal or digital assets for the haptic emoji to a device of a second user.

In some embodiments, the haptic emoji is predicted and the processing further comprises obtaining the digital assets for the haptic emoji, and the digital assets comprise the haptic signal configured with parameter information to generate patterns for haptic output.

In some embodiments, the haptic signal is configured with the parameter information for interval, pitch, and amplitude to generate the patterns for the haptic output.

In some embodiments, the digital assets further comprise an image or video asset, an audio asset, or both.

In various embodiments, an extended reality system is provided that includes: a head-mounted device comprising a display to display content to a first user, one or more sensors to capture input data including images of a visual field of the first user, one or more processors, and one or more memories accessible to the one or more processors, the one or more memories storing a plurality of instructions executable by the one or more processors, the plurality of instructions comprising instructions that when executed by the one or more processors cause the one or more processors to perform processing comprising: receiving, at the head-mounted device, a haptic signal from a second user, wherein the haptic signal is configured with parameter information on interval, pitch, amplitude, or a combination thereof for a touch message to be perceived by the first user's body, determining parameters of one or more actuator signals based on the haptic signal, generating the one or more actuator signals based on the parameters determined for the one or more actuator signals, transmitting the one or more actuator signals to one or more corresponding cutaneous actuators, and generating, by the one or more cutaneous actuators, haptic output in accordance with the corresponding one or more actuator signals, wherein the haptic output conveys the touch message to the first user's body.

In some embodiments, the parameters of the one or more actuator signals include information on pressure, temperature, texture, sheer stress, time, space, or a combination thereof.

In some embodiments, the processing further comprises prior to generating the one or more actuator signals, adjusting the parameter information on the interval, pitch, amplitude, or a combination thereof for the haptic signal in accordance with preferences of the first user.

In some embodiments, the processing further comprises prior to generating the one or more actuator signals, adjusting the parameter information on the pressure, temperature, texture, sheer stress, time, space, or a combination thereof for the one or more actuator signals in accordance with preferences of the first user.

In some embodiments, the processing further comprises obtaining additional information based on an emoji or the haptic signal, the additional information includes a text description of the haptic output conveyed by the haptic signal, an audio component corresponding to the haptic signal, an image component corresponding to the haptic signal, or a combination thereof, and the haptic output is generated with virtual content, which is generated and rendered by the head-mounted device in an extended reality environment displayed to the first user based on the additional information.

Some embodiments of the present disclosure include a computer-implemented method comprising part or all of one or more methods and/or part or all of one or more processes disclosed herein.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein.

Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a network environment in accordance with various embodiments.

FIG. 2A an illustration depicting an example extended reality system that presents and controls user interface elements within an extended reality environment in accordance with various embodiments.

FIG. 2B an illustration depicting user interface elements in accordance with various embodiments.

FIG. 3A is an illustration of an augmented reality system in accordance with various embodiments.

FIG. 3B is an illustration of a virtual reality system in accordance with various embodiments.

FIG. 4A is an illustration of haptic devices in accordance with various embodiments.

FIG. 4B is an illustration of an exemplary virtual reality environment in accordance with various embodiments.

FIG. 4C is an illustration of an exemplary augmented reality environment in accordance with various embodiments.

FIG. 5 is a simplified block diagram of a social communication platform in accordance with various embodiments.

FIG. 6A is a simplified block diagram illustrating a social communication system for converting input data to haptic output using a lexicon of emojis in accordance with various embodiments.

FIG. 6B is an illustration of digital assets for a lexicon of emojis in accordance with various embodiments.

FIG. 6C is an illustration of digital assets for a lexicon of emojis in accordance with various embodiments.

FIG. 7 is a flowchart illustrating a process for converting input data to haptic output using a lexicon of emojis in accordance with various embodiments.

FIG. 8 is a simplified block diagram illustrating a machine-learning prediction system in accordance with various embodiments.

FIG. 9 is a flowchart illustrating a process to predict haptic emojis for conveying a touch message in accordance with various embodiments.

FIG. 10 is a simplified block diagram illustrating a social communication system for supplementing a haptic signal with additional information to facilitate a user learning a haptic output in accordance with various embodiments.

FIG. 11 is a flowchart illustrating a process for supplementing a haptic signal with additional information to facilitate a user learning a haptic output in accordance with various embodiments.

FIG. 12 is a simplified block diagram illustrating a signal generator for operating cutaneous actuators to deliver haptic output (tactile feedback) to a user in accordance with various embodiments.

FIG. 13 is a flowchart illustrating a process for generating a haptic output in accordance with various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

Extended reality systems are becoming increasingly ubiquitous with applications in many fields such as computer gaming, health and safety, industrial, and education. As a few examples, extended reality systems are being incorporated into mobile devices, gaming consoles, personal computers, movie theaters, and theme parks. Typical extended reality systems include one or more devices for rendering and displaying content to users. As one example, an extended reality system may incorporate a HMD worn by a user and configured to output extended reality content to the user. The extended reality content may be generated in a wholly or partially simulated environment (extended reality environment) that people sense and/or interact with via an electronic system. The simulated environment may be a VR environment, which is designed to be based entirely on computer-generated sensory inputs (e.g., virtual content) for one or more user senses, or a MR environment, which is designed to incorporate sensory inputs (e.g., a view of the physical surroundings) from the physical environment, or a representation thereof, in addition to including computer-generated sensory inputs (e.g., virtual content). Examples of MR include AR and augmented virtuality (AV). An AR environment is a simulated environment in which one or more virtual objects are superimposed over a physical environment, or a representation thereof, or a simulated environment in which a representation of a physical environment is transformed by computer-generated sensory information. An AV environment refers to a simulated environment in which a virtual or computer-generated environment incorporates one or more sensory inputs from the physical environment. In any instance—VR. MR, AR, or VR, during operation, the user typically interacts with the extended reality system to interact with extended reality content.

Extended reality systems can be used to facilitate social communities and interactions amongst users. For example, extended reality systems can allow users to communicate content and emotion via visual (e.g., via text message and visual emojis) and audible (e.g., via voice or synthetic sounds such as audible emojis) communication. However, there is currently limited means for touch communication between users (e.g., haptic, kinesthetic, or cutaneous communication). Haptic, kinesthetic, and cutaneous communication refers to the ways in which humans communicate and interact via the sense of touch, and measure information arising from physical interaction with their environment. Haptic sense and touch include information about surfaces and textures, and is a component of communication that is nonverbal and nonvisual. However, touch communication between users often depends on whether the users are present in the same location. For example, when users are next to one another in the real world it is easy for one user to tap the shoulder of another user to get their attention, or squeeze their hand to express joy or love, or gently grasp their arm to provide reassurance. In contrast, touch communication between users at different locations (remote settings), which is often the case in extended reality, is often not feasible and it is difficult to convey tactile messages simply via visual and/or audio communication.

In order overcome these challenges and others, techniques are disclosed herein for sending and receiving tactile messages (e.g., haptic emojis) in an extended reality environment to facilitate touch communication between users. In an exemplary embodiment, an extended reality system is provided comprising: a head-mounted device comprising a display to display content to a first user, one or more sensors to capture input data including images of a visual field of the first user; one or more processors; and one or more memories accessible to the one or more processors, the one or more memories storing a plurality of instructions executable by the one or more processors, the plurality of instructions comprising instructions that when executed by the one or more processors cause the one or more processors to perform processing comprising: capturing, using the one or more sensors, the input data from the first user; extracting features from the input data that correspond to an electronic communication; identifying an emoji from a lexicon of emojis based on the extracted features; obtaining digital assets for the emoji, wherein the digital assets comprise a haptic signal configured with parameter information to generate patterns for haptic output; and transmitting the digital assets to a device of a second user.

In another exemplary embodiment, an extended reality system is provided comprising: a head-mounted device comprising a display to display content to a first user, one or more sensors to capture input data including images of a visual field of the first user; one or more processors; and one or more memories accessible to the one or more processors, the one or more memories storing a plurality of instructions executable by the one or more processors, the plurality of instructions comprising instructions that when executed by the one or more processors cause the one or more processors to perform processing comprising: capturing, using the one or more sensors, the input data from the first user; predicting a haptic emoji or a haptic signal based on the input data and model parameters learned from historical input data and context data; and transmitting the haptic signal or digital assets for the haptic emoji to a device of a second user.

In another exemplary embodiment, an extended reality system is provided comprising: a head-mounted device comprising a display to display content to a first user, one or more sensors to capture input data including images of a visual field of the first user; one or more processors; and one or more memories accessible to the one or more processors, the one or more memories storing a plurality of instructions executable by the one or more processors, the plurality of instructions comprising instructions that when executed by the one or more processors cause the one or more processors to perform processing comprising: receiving, at the head-mounted device, a haptic signal from a second user, where the haptic signal is configured with parameter information on interval, pitch, amplitude, or a combination thereof for a touch message to be perceived by the first user's body; determining parameters of one or more actuator signals based on the haptic signal; generating the one or more actuator signals based on the parameters determined for the one or more actuator signals; transmitting the one or more actuator signals to one or more corresponding cutaneous actuators; and generating, by the one or more cutaneous actuators, haptic output in accordance with the corresponding one or more actuator signals, where the haptic output conveys the touch message to the first user's body.

Advantageously, the tactile messages are more expressive than visual or audio based messages, and are particularly useful when a user can't view or listen to visual or audio based messages.

### Extended Reality System Overview

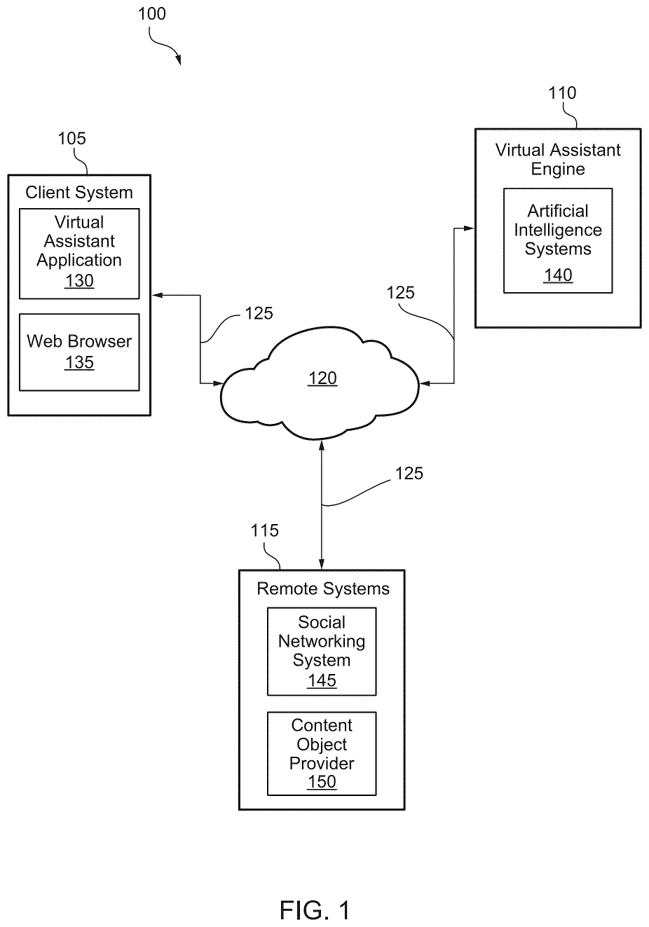

FIG. 1 illustrates an example network environment 100 associated with an extended reality system in accordance with aspects of the present disclosure. Network environment 100 includes a client system 105, a virtual assistant engine 110, and remote systems 115 connected to each other by a network 120. Although FIG. 1 illustrates a particular arrangement of a client system 105, a virtual assistant engine 110, remote systems 115, and a network 120, this disclosure contemplates any suitable arrangement of a client system 105, a virtual assistant engine 110, remote systems 115, and a network 120. As an example, and not by way of limitation, two or more of client systems 105, a virtual assistant engine 110, and a remote systems 115 may be connected to each other directly, bypassing the network 120. As another example, two or more of aa client system 105, a virtual assistant engine 110, and remote systems 115 may be physically or logically co-located with each other in whole or in part. Moreover, although FIG. 1 illustrates a particular number of a client system 105, a virtual assistant engine 110, remote systems 115, and networks 120, this disclosure contemplates any suitable number of client systems 105, virtual assistant engines 110, remote systems 115, and networks 120. As an example, and not by way of limitation, network environment 100 may include multiple client systems 105, virtual assistant engines 110, remote systems 115, and networks 115.

This disclosure contemplates any suitable network 120. As an example and not by way of limitation, one or more portions of a network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 120 may include one or more networks 120.

Links 125 may connect a client system 105, a virtual assistant engine 110, and a remote system 115 to a communication network 110 or to each other. This disclosure contemplates any suitable links 125. In particular embodiments, one or more links 125 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 125 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 125, or a combination of two or more such links 125. Links 125 need not necessarily be the same throughout a network environment 100. One or more first links 125 may differ in one or more respects from one or more second links 125.

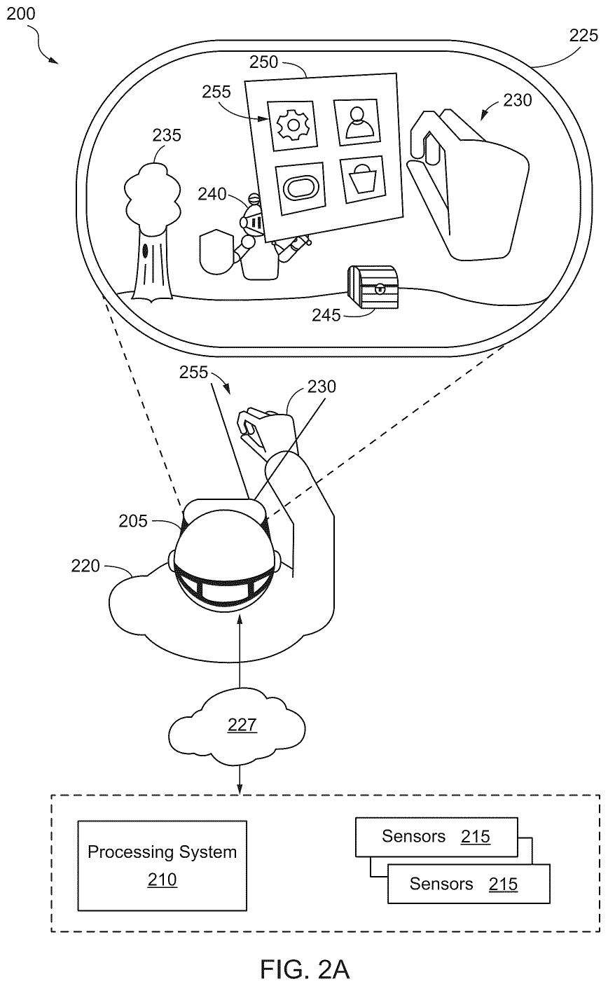

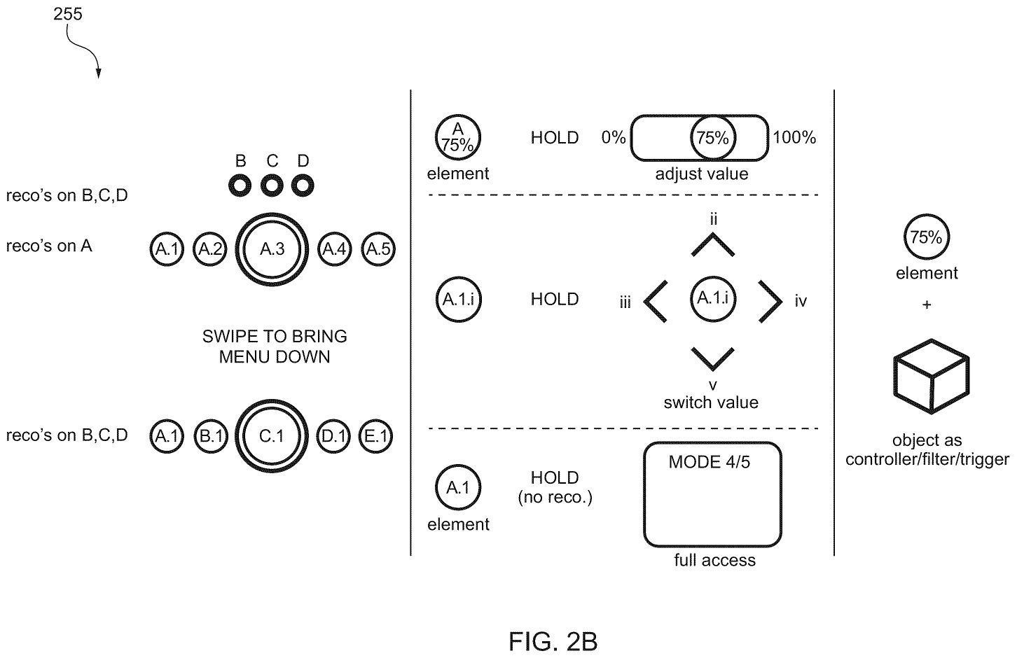

In various embodiments, a client system 105 is an electronic device including hardware, software, or embedded logic components or a combination of two or more such components and capable of carrying out the appropriate extended reality functionalities in accordance with techniques of the disclosure. As an example, and not by way of limitation, a client system 105 may include a desktop computer, notebook or laptop computer, netbook, a tablet computer, e-book reader, GPS device, camera, personal digital assistant (PDA), handheld electronic device, cellular telephone, smartphone, a VR. MR, AR, or VR headset such as an AR/VR HMD, other suitable electronic device capable of displaying extended reality content, or any suitable combination thereof. In particular embodiments, the client system 105 is an AR/VR HMD as described in detail with respect to FIG. 2. This disclosure contemplates any suitable client system 105 configured to generate and output extended reality content to the user. The client system 105 may enable its user to communicate with other users at other client systems 105.

In various embodiments, the client system 105 includes a virtual assistant application 130. The virtual assistant application 130 instantiates at least a portion of the virtual assistant, which can provide information or services to a user based on user input, contextual awareness (such as clues from the physical environment or clues from user behavior), and the capability to access information from a variety of online sources (such as weather conditions, traffic information, news, stock prices, user schedules, retail prices, etc.). As used herein, when an action is “based on” something, this means the action is based at least in part on at least a part of the something. The user input may include text (e.g., online chat), especially in an instant messaging application or other applications, voice, eye-tracking, user motion such as gestures or running, or a combination of them. The virtual assistant may perform concierge-type services (e.g., making dinner reservations, purchasing event tickets, making travel arrangements, and the like), provide information (e.g., reminders, information concerning an object in an environment, information concerning a task or interaction, answers to questions, training regarding a task or activity, and the like), goal assisted services (e.g., generating and implementing a recipe to cook a meal in a certain amount of time, implementing tasks to clean in a most efficient manner, generate and execute a construction plan including allocation of tasks to two or more workers, and the like), or combinations thereof. The virtual assistant may also perform management or data-handling tasks based on online information and events without user initiation or interaction. Examples of those tasks that may be performed by a virtual assistant may include schedule management (e.g., sending an alert to a dinner date that a user is running late due to traffic conditions, update schedules for both parties, and change the restaurant reservation time). The virtual assistant may be enabled in an extended reality environment by a combination of the client system 105, the virtual assistant engine 110, application programming interfaces (APIs), and the proliferation of applications on user devices such as the remote systems 115.

A user at the client system 105 may use the virtual assistant application 130 to interact with the virtual assistant engine 110. In some instances, the virtual assistant application 130 is a stand-alone application or integrated into another application such as a social-networking application or another suitable application (e.g., an artificial simulation application). In some instances, the virtual assistant application 130 is integrated into the client system 105 (e.g., part of the operating system of the client system 105), an assistant hardware device, or any other suitable hardware devices. In some instances, the virtual assistant application 130 may be accessed via a web browser 135. In some instances, the virtual assistant application 130 passively listens to and watches interactions of the user in the real-world, and processes what it hears and sees (e.g., explicit input such as audio commands or interface commands, contextual awareness derived from audio or physical actions of the user, objects in the real-world, environmental triggers such as weather or time, and the like) in order to interact with the user in an intuitive manner.

In particular embodiments, the virtual assistant application 130 receives or obtains input from a user, the physical environment, a virtual reality environment, or a combination thereof via different modalities. As an example, and not by way of limitation, the modalities may include audio, text, image, video, motion, graphical or virtual user interfaces, orientation, sensors, etc. The virtual assistant application 130 communicates the input to the virtual assistant engine 110. Based on the input, the virtual assistant engine 110 analyzes the input and generates responses (e.g., text or audio responses, device commands such as a signal to turn on a television, virtual content such as a virtual object, or the like) as output. The virtual assistant engine 110 may send the generated responses to the virtual assistant application 130, the client system 105, the remote systems 115, or a combination thereof. The virtual assistant application 130 may present the response to the user at the client system 130 (e.g., rendering virtual content overlaid on a real-world object within the display). The presented responses may be based on different modalities such as audio, text, image, and video. As an example, and not by way of limitation, context concerning activity of a user in the physical world may be analyzed and determined to initiate an interaction for completing an immediate task or goal, which may include the virtual assistant application 130 retrieving traffic information (e.g., via a remote system 115). The virtual assistant application 130 may communicate the request for traffic information to virtual assistant engine 110. The virtual assistant engine 110 may accordingly contact the remote system 115 and retrieve traffic information as a result of the request and send the traffic information back to the virtual assistant application 110. The virtual assistant application 110 may then present the traffic information to the user as text (e.g., as virtual content overlaid on the physical environment such as real-world object) or audio (e.g., spoken to the user in natural language through a speaker associated with the client system 105).

In various embodiments, the virtual assistant engine 110 assists users to retrieve information from different sources, request services from different service providers, assist users to learn or complete goals and tasks using different sources and/or service providers, and combinations thereof. In some instances, the virtual assistant engine 110 receives input data from the virtual assistant application 130 and determines one or more interactions based on the input data that could be executed to request information, services, and/or complete a goal or task of the user. The interactions are actions that could be presented to a user for execution in an extended reality environment. In some instances, the interactions are influenced by other actions associated with the user. The interactions are aligned with goals or tasks associated with the user. The goals may comprise, for example, things that a user wants to occur such as a meal, a piece of furniture, a repaired automobile, a house, a garden, a clean apartment, and the like. The tasks may comprise, for example, cooking a meal using one or more recipes, building a piece of furniture, repairing a vehicle, building a house, planting a garden, cleaning one or more rooms of an apartment, and the like. Each goal and task may be associated with a workflow of actions or sub-tasks for performing the task and achieving the goal. For example, for preparing a salad, the a workflow of actions or sub-tasks may comprise ingredients needed, any equipment need for the steps (e.g., a knife, a stove top, a pan, a salad spinner, etc.), sub-tasks for preparing ingredients (e.g., chopping onions, cleaning lettuce, cooking chicken, etc.), and sub-tasks for combining ingredients into subcomponents (e.g., cooking chicken with olive oil and Italian seasonings).

The virtual assistant engine 110 may use artificial intelligence systems 140 (e.g., rule-based systems or machine-learning based systems such as natural-language understanding models) to analyze the input based on a user's profile and other relevant information. The result of the analysis may comprise different interactions associated with a task or goal of the user. The virtual assistant 110 may then retrieve information, request services, and/or generate instructions, recommendations, or virtual content associated with one or more of the different interactions for completing tasks or goals. In some instances, the virtual assistant engine 110 interacts with a remote system 115 such as a social-networking system 145 when retrieving information, requesting service, and/or generate instructions or recommendations for the user. The virtual assistant engine 110 may generate virtual content for the user using various techniques such as natural language generating, virtual object rendering, and the like. The virtual content may comprise, for example, the retrieved information, the status of the requested services, a virtual object such as a glimmer overlaid on a physical object such as a appliance, light, or piece of exercise equipment, a demonstration for a task, and the like. In particular embodiments, the virtual assistant engine 110 enables the user to interact with it regarding the information, services, or goals using a graphical or virtual interface, a stateful and multi-turn conversation using dialog-management techniques, and/or a stateful and multi-action interaction using task-management techniques.

In various embodiments, a remote system 115 may include one or more types of servers, one or more data stores, one or more interfaces, including but not limited to APIs, one or more web services, one or more content sources, one or more networks, or any other suitable components, e.g., that servers may communicate with. A remote system 115 may be operated by a same entity or a different entity from an entity operating the virtual assistant engine 110. In particular embodiments, however, the virtual assistant engine 110 and third-party systems 115 may operate in conjunction with each other to provide virtual content to users of the client system 105. For example, a social-networking system 145 may provide a platform, or backbone, which other systems, such as third-party systems, may use to provide social-networking services and functionality to users across the Internet, and the virtual assistant engine 110 may access these systems to provide virtual content on the client system 105.

In particular embodiments, the social-networking system 145 may be a network-addressable computing system that can host an online social network. The social-networking system 145 may generate, store, receive, and send social-networking data, such as, for example, user-profile data, concept-profile data, social-graph information, or other suitable data related to the online social network. The social-networking system 145 may be accessed by the other components of network environment 100 either directly or via a network 120. As an example, and not by way of limitation, a client system 105 may access the social-networking system 145 using a web browser 135, or a native application associated with the social-networking system 145 (e.g., a mobile social-networking application, a messaging application, another suitable application, or any combination thereof) either directly or via a network 120. The social-networking system 145 may provide users with the ability to take actions on various types of items or objects, supported by the social-networking system 145. As an example and not by way of limitation, the items and objects may include groups or social networks to which users of the social-networking system 145 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 145 or by an external system of the remote systems 115, which is separate from the social-networking system 145 and coupled to the social-networking system 115 via the network 120.

The remote system 115 may include a content object provider 150. A content object provider 150 includes one or more sources of virtual content objects, which may be communicated to the client system 105. As an example, and not by way of limitation, virtual content objects may include information regarding things or activities of interest to the user, such as, for example, movie show times, movie reviews, restaurant reviews, restaurant menus, product information and reviews, instructions on how to perform various tasks, exercise regimens, cooking recipes, or other suitable information. As another example and not by way of limitation, content objects may include incentive content objects, such as coupons, discount tickets, gift certificates, or other suitable incentive objects. As another example and not by way of limitation, content objects may include virtual objects such as virtual interfaces, 2D or 3D graphics, media content, or other suitable virtual objects.

FIG. 2A illustrates an example client system 200 (e.g., client system 105 described with respect to FIG. 1) in accordance with aspects of the present disclosure. Client system 200 includes an extended reality system 205 (e.g., a HMD), a processing system 210, and one or more sensors 215. As shown, extended reality system 205 is typically worn by user 220 and comprises an electronic display (e.g., a transparent, translucent, or solid display), optional controllers, and optical assembly for presenting extended reality content 225 to the user 220. The one or more sensors 215 may include motion sensors (e.g., accelerometers) for tracking motion of the extended reality system 205 and may include one or more image capture devices (e.g., cameras, line scanners) for capturing image data of the surrounding physical environment. In this example, processing system 210 is shown as a single computing device, such as a gaming console, workstation, a desktop computer, or a laptop. In other examples, processing system 210 may be distributed across a plurality of computing devices, such as a distributed computing network, a data center, or a cloud computing system. In other examples, processing system 210 may be integrated with the extended reality system 205. The extended reality system 205, the processing system 210, and the one or more sensors 215 are communicatively coupled via a network 227, which may be a wired or wireless network, such as Wi-Fi, a mesh network or a short-range wireless communication medium such as Bluetooth wireless technology, or a combination thereof. Although extended reality system 205 is shown in this example as in communication with, e.g., tethered to or in wireless communication with, processing system 210, in some implementations extended reality system 205 operates as a stand-alone, mobile extended reality system.

In general, client system 200 uses information captured from a real-world, physical environment to render extended reality content 225 for display to the user 220. In the example of FIG. 2, the user 220 views the extended reality content 225 constructed and rendered by an extended reality application executing on processing system 210 and/or extended reality system 205. In some examples, the extended reality content 225 viewed through the extended reality system 205 comprises a mixture of real-world imagery (e.g., the user's hand 230 and physical objects 235) and virtual imagery (e.g., virtual content such as information or objects 240, 245 and virtual user interface 250) to produce mixed reality and/or augmented reality. In some examples, virtual information or objects 240, 245 may be mapped (e.g., pinned, locked, placed) to a particular position within extended reality content 225. For example, a position for virtual information or objects 240, 245 may be fixed, as relative to one of walls of a residence or surface of the earth, for instance. A position for virtual information or objects 240, 245 may be variable, as relative to a physical object 235 or the user 220, for instance. In some examples, the particular position of virtual information or objects 240, 245 within the extended reality content 225 is associated with a position within the real world, physical environment (e.g., on a surface of a physical object 235).

In the example shown in FIG. 2A, virtual information or objects 240, 245 are mapped at a position relative to a physical object 235. As should be understood, the virtual imagery (e.g., virtual content such as information or objects 240, 245 and virtual user interface 250) does not exist in the real-world, physical environment. Virtual user interface 250 may be fixed, as relative to the user 220, the user's hand 230, physical objects 235, or other virtual content such as virtual information or objects 240, 245, for instance. As a result, client system 200 renders, at a user interface position that is locked relative to a position of the user 220, the user's hand 230, physical objects 235, or other virtual content in the extended reality environment, virtual user interface 250 for display at extended reality system 205 as part of extended reality content 225. As used herein, a virtual element ‘locked’ to a position of virtual content or physical object is rendered at a position relative to the position of the virtual content or physical object so as to appear to be part of or otherwise tied in the extended reality environment to the virtual content or physical object.

In some implementations, the client system 200 generates and renders virtual content (e.g., GIFs, photos, applications, live-streams, videos, text, a web-browser, drawings, animations, representations of data files, or any other visible media) on a virtual surface. A virtual surface may be associated with a planar or other real-world surface (e.g., the virtual surface corresponds to and is locked to a physical surface, such as a wall table, or ceiling). In the example shown in FIG. 2A, the virtual surface is associated with the sky and ground of the physical environment. In other examples, a virtual surface can be associated with a portion of a surface (e.g., a portion of the wall). In some examples, only the virtual content items contained within a virtual surface are rendered. In other examples, the virtual surface is generated and rendered (e.g., as a virtual plane or as a border corresponding to the virtual surface). In some examples, a virtual surface can be rendered as floating in a virtual or real-world physical environment (e.g., not associated with a particular real-world surface). The client system 200 may render one or more virtual content items in response to a determination that at least a portion of the location of virtual content items is in a field of view of the user 220. For example, client system 200 may render virtual user interface 250 only if a given physical object (e.g., a lamp) is within the field of view of the user 220.

During operation, the extended reality application constructs extended reality content 225 for display to user 220 by tracking and computing interaction information (e.g., tasks for completion) for a frame of reference, typically a viewing perspective of extended reality system 205. Using extended reality system 205 as a frame of reference and based on a current field of view as determined by a current estimated interaction of extended reality system 205, the extended reality application renders extended reality content 225 which, in some examples, may be overlaid, at least in part, upon the real-world, physical environment of the user 220. During this process, the extended reality application uses sensed data received from extended reality system 205 and sensors 215, such as movement information, contextual awareness, and/or user commands, and, in some examples, data from any external sensors, such as third-party information or device, to capture information within the real world, physical environment, such as motion by user 220 and/or feature tracking information with respect to user 220. Based on the sensed data, the extended reality application determines interaction information to be presented for the frame of reference of extended reality system 205 and, in accordance with the current context of the user 220, renders the extended reality content 225.

Client system 200 may trigger generation and rendering of virtual content based on a current field of view of user 220, as may be determined by real-time gaze 255 tracking of the user, or other conditions. More specifically, image capture devices of the sensors 215 capture image data representative of objects in the real world, physical environment that are within a field of view of image capture devices. During operation, the client system 200 performs object recognition within image data captured by the image capture devices of extended reality system 205 to identify objects in the physical environment such as the user 220, the user's hand 230, and/or physical objects 235. Further, the client system 200 tracks the position, orientation, and configuration of the objects in the physical environment over a sliding window of time. Field of view typically corresponds with the viewing perspective of the extended reality system 205. In some examples, the extended reality application presents extended reality content 225 comprising mixed reality and/or augmented reality.

As illustrated in FIG. 2A, the extended reality application may render virtual content, such as virtual information or objects 240, 245 on a transparent display such that the virtual content is overlaid on real-world objects, such as the portions of the user 220, the user's hand 230, physical objects 235, that are within a field of view of the user 220. In other examples, the extended reality application may render images of real-world objects, such as the portions of the user 220, the user's hand 230, physical objects 235, that are within field of view along with virtual objects, such as virtual information or objects 240, 245 within extended reality content 225. In other examples, the extended reality application may render virtual representations of the portions of the user 220, the user's hand 230, physical objects 235 that are within field of view (e.g., render real-world objects as virtual objects) within extended reality content 225. In either example, user 220 is able to view the portions of the user 220, the user's hand 230, physical objects 235 and/or any other real-world objects or virtual content that are within field of view within extended reality content 225. In other examples, the extended reality application may not render representations of the user 220 and the user's hand 230; and instead, only render the physical objects 235 and/or virtual information or objects 240, 245.

In various embodiments, the client system 200 renders to extended reality system 205 extended reality content 225 in which virtual user interface 250 is locked relative to a position of the user 220, the user's hand 230, physical objects 235, or other virtual content in the extended reality environment. That is, the client system 200 may render a virtual user interface 250 having one or more virtual user interface elements at a position and orientation that is based on and corresponds to the position and orientation of the user 220, the user's hand 230, physical objects 235, or other virtual content in the extended reality environment. For example, if a physical object is positioned in a vertical position on a table, the client system 200 may render the virtual user interface 250 at a location corresponding to the position and orientation of the physical object in the extended reality environment. Alternatively, if the user's hand 230 is within the field of view, the client system 200 may render the virtual user interface at a location corresponding to the position and orientation of the user's hand 230 in the extended reality environment. Alternatively, if other virtual content is within the field of view, the client system 200 may render the virtual user interface at a location corresponding to a general predetermined position of the field of view (e.g., a bottom of the field of view) in the extended reality environment. Alternatively, if other virtual content is within the field of view, the client system 200 may render the virtual user interface at a location corresponding to the position and orientation of the other virtual content in the extended reality environment. In this way, the virtual user interface 250 being rendered in the virtual environment may track the user 220, the user's hand 230, physical objects 235, or other virtual content such that the user interface appears, to the user, to be associated with the user 220, the user's hand 230, physical objects 235, or other virtual content in the extended reality environment.

The virtual user interface 250 may include one or more virtual user interface elements 255. As shown in FIG. 2B, the virtual user interface elements 255 may include, for instance, a virtual drawing interface, a selectable menu (e.g., a drop-down menu), virtual buttons, a virtual slider or scroll bar, a directional pad, a keyboard, or other user-selectable user interface elements, glyphs, display elements, content, user interface controls, and so forth. The particular virtual user interface elements 255 for virtual user interface 250 may be context-driven based on the current extended reality applications engaged by the user 220 or real-world actions/tasks being performed by the user 220. When a user performs a user interface gesture in the extended reality environment at a location that corresponds to one of the virtual user interface elements 255 of virtual user interface 250, the client system 200 detects the gesture relative to the virtual user interface elements 255 and performs an action associated with the gesture and the virtual user interface elements 255. For example, the user 220 may press their finger at a button element 255 location on the virtual user interface 250. The button element 255 and/or virtual user interface 250 location may or may not be overlaid on the user 220, the user's hand 230, physical objects 235, or other virtual content, e.g., correspond to a position in the physical environment such as on a light switch or controller at which the client system 200 renders the virtual user interface button. In this example, the client system 200 detects this virtual button press gesture and performs an action corresponding to the detected press of a virtual user interface button (e.g., turns the light on). The client system 200 may also, for instance, animate a press of the virtual user interface button along with the button press gesture.

The client system 200 may detect user interface gestures and other gestures using an inside-out or outside-in tracking system of image capture devices and or external cameras. The client system 200 may alternatively, or in addition, detect user interface gestures and other gestures using a presence-sensitive surface. That is, a presence-sensitive interface of the extended reality system 205 and/or controller may receive user inputs that make up a user interface gesture. The extended reality system 205 and/or controller may provide haptic feedback to touch-based user interaction by having a physical surface with which the user can interact (e.g., touch, drag a finger across, grab, and so forth). In addition, peripheral extended reality system 205 and/or controller may output other indications of user interaction using an output device. For example, in response to a detected press of a virtual user interface button, extended reality system 205 and/or controller may output a vibration or “click” noise, or extended reality system 205 and/or controller may generate and output content to a display. In some examples, the user 220 may press and drag their finger along physical locations on the extended reality system 205 and/or controller corresponding to positions in the virtual environment at which the client system 200 renders virtual user interface elements 255 of virtual user interface 250. In this example, the client system 200 detects this gesture and performs an action according to the detected press and drag of virtual user interface elements 255, such as by moving a slider bar in the virtual environment. In this way, client system 200 simulates movement of virtual content using virtual user interface elements 255 and gestures.

Various embodiments disclosed herein may include or be implemented in conjunction with various types of extended reality systems. Extended reality content generated by the extended reality systems may include completely computer-generated content or computer-generated content combined with captured (e.g., real-world) content. The extended reality content may include video, audio, haptic feedback, or some combination thereof, any of which may be presented in a single channel or in multiple channels (such as stereo video that produces a three-dimensional (3D) effect to the viewer). Additionally, in some embodiments, extended reality may also be associated with applications, products, accessories, services, or some combination thereof, that are used to, for example, create content in an extended reality and/or are otherwise used in (e.g., to perform activities in) an extended reality.

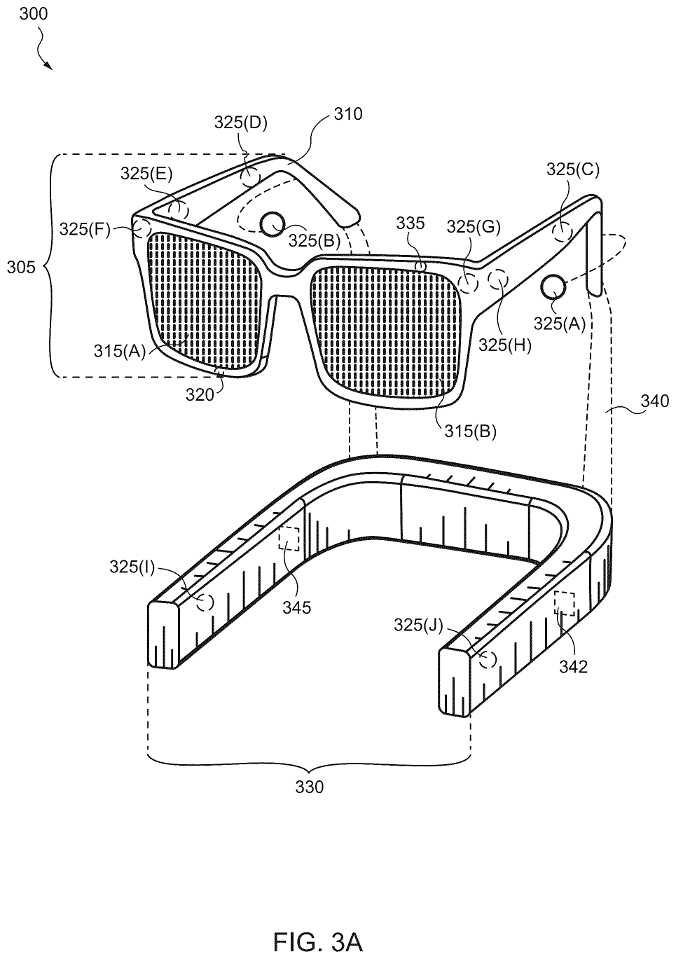

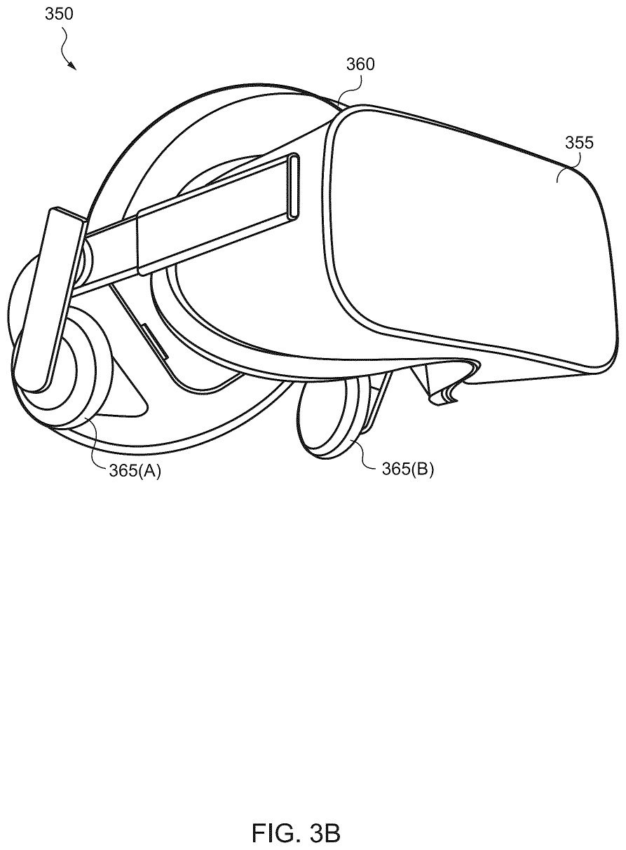

The extended reality systems may be implemented in a variety of different form factors and configurations. Some extended reality systems may be designed to work without near-eye displays (NEDs). Other extended reality systems may include an NED that also provides visibility into the real world (such as, e.g., augmented reality system 300 in FIG. 3A) or that visually immerses a user in an extended reality (such as, e.g., virtual reality system 350 in FIG. 3B). While some extended reality devices may be self-contained systems, other extended reality devices may communicate and/or coordinate with external devices to provide an extended reality experience to a user. Examples of such external devices include handheld controllers, mobile devices, desktop computers, devices worn by a user, devices worn by one or more other users, and/or any other suitable external system.

As shown in FIG. 3A, augmented reality system 300 may include an eyewear device 305 with a frame 310 configured to hold a left display device 315(A) and a right display device 315(B) in front of a user's eyes. Display devices 315(A) and 315(B) may act together or independently to present an image or series of images to a user. While augmented reality system 300 includes two displays, embodiments of this disclosure may be implemented in augmented reality systems with a single NED or more than two NEDs.

In some embodiments, augmented reality system 300 may include one or more sensors, such as sensor 320. Sensor 320 may generate measurement signals in response to motion of augmented reality system 300 and may be located on substantially any portion of frame 310. Sensor 320 may represent one or more of a variety of different sensing mechanisms, such as a position sensor, an inertial measurement unit (IMU), a depth camera assembly, a structured light emitter and/or detector, or any combination thereof. In some embodiments, augmented reality system 300 may or may not include sensor 320 or may include more than one sensor. In embodiments in which sensor 320 includes an IMU, the IMU may generate calibration data based on measurement signals from sensor 320. Examples of sensor 320 may include, without limitation, accelerometers, gyroscopes, magnetometers, other suitable types of sensors that detect motion, sensors used for error correction of the IMU, or some combination thereof.

In some examples, augmented reality system 300 may also include a microphone array with a plurality of acoustic transducers 325(A)-325(J), referred to collectively as acoustic transducers 325. Acoustic transducers 325 may represent transducers that detect air pressure variations induced by sound waves. Each acoustic transducer 325 may be configured to detect sound and convert the detected sound into an electronic format (e.g., an analog or digital format). The microphone array in FIG. 3A may include, for example, ten acoustic transducers: 325(A) and 325(B), which may be designed to be placed inside a corresponding ear of the user, acoustic transducers 325(C), 325(D), 325(E), 325(F), 325(G), and 325(H), which may be positioned at various locations on frame 310, and/or acoustic transducers 325(I) and 325(J), which may be positioned on a corresponding neckband 330.

In some embodiments, one or more of acoustic transducers 325(A)-(J) may be used as output transducers (e.g., speakers). For example, acoustic transducers 325(A) and/or 325(B) may be earbuds or any other suitable type of headphone or speaker. The configuration of acoustic transducers 325 of the microphone array may vary. While augmented reality system 300 is shown in FIG. 3 as having ten acoustic transducers 325, the number of acoustic transducers 325 may be greater or less than ten. In some embodiments, using higher numbers of acoustic transducers 325 may increase the amount of audio information collected and/or the sensitivity and accuracy of the audio information. In contrast, using a lower number of acoustic transducers 325 may decrease the computing power required by an associated controller 335 to process the collected audio information. In addition, the position of each acoustic transducer 325 of the microphone array may vary. For example, the position of an acoustic transducer 325 may include a defined position on the user, a defined coordinate on frame 310, an orientation associated with each acoustic transducer 325, or some combination thereof.

Acoustic transducers 325(A) and 325(B) may be positioned on different parts of the user's ear, such as behind the pinna, behind the tragus, and/or within the auricle or fossa. Or, there may be additional acoustic transducers 325 on or surrounding the ear in addition to acoustic transducers 325 inside the ear canal. Having an acoustic transducer 325 positioned next to an ear canal of a user may enable the microphone array to collect information on how sounds arrive at the ear canal. By positioning at least two of acoustic transducers 325 on either side of a user's head (e.g., as binaural microphones), augmented reality system 300 may simulate binaural hearing and capture a 3D stereo sound field around about a user's head. In some embodiments, acoustic transducers 325(A) and 325(B) may be connected to augmented reality system 300 via a wired connection 340, and in other embodiments acoustic transducers 325(A) and 325(B) may be connected to augmented reality system 300 via a wireless connection (e.g., a Bluetooth connection). In still other embodiments, acoustic transducers 325(A) and 325(B) may not be used at all in conjunction with augmented reality system 300.

Acoustic transducers 325 on frame 310 may be positioned in a variety of different ways, including along the length of the temples, across the bridge, above or below display devices 315(A) and 315(B), or some combination thereof. Acoustic transducers 325 may also be oriented such that the microphone array is able to detect sounds in a wide range of directions surrounding the user wearing the augmented reality system 300. In some embodiments, an optimization process may be performed during manufacturing of augmented reality system 300 to determine relative positioning of each acoustic transducer 325 in the microphone array.

In some examples, augmented reality system 300 may include or be connected to an external device (e.g., a paired device), such as neckband 330. Neckband 330 generally represents any type or form of paired device. Thus, the following discussion of neckband 330 may also apply to various other paired devices, such as charging cases, smart watches, smart phones, wrist bands, other wearable devices, hand-held controllers, tablet computers, laptop computers, other external compute devices, etc.

As shown, neckband 330 may be coupled to eyewear device 305 via one or more connectors. The connectors may be wired or wireless and may include electrical and/or non-electrical (e.g., structural) components. In some cases, eyewear device 305 and neckband 330 may operate independently without any wired or wireless connection between them. While FIG. 3A illustrates the components of eyewear device 305 and neckband 330 in example locations on eyewear device 305 and neckband 330, the components may be located elsewhere and/or distributed differently on eyewear device 305 and/or neckband 330. In some embodiments, the components of eyewear device 305 and neckband 330 may be located on one or more additional peripheral devices paired with eyewear device 305, neckband 330, or some combination thereof.

Pairing external devices, such as neckband 330, with augmented reality eyewear devices may enable the eyewear devices to achieve the form factor of a pair of glasses while still providing sufficient battery and computation power for expanded capabilities. Some or all of the battery power, computational resources, and/or additional features of augmented reality system 300 may be provided by a paired device or shared between a paired device and an eyewear device, thus reducing the weight, heat profile, and form factor of the eyewear device overall while still retaining desired functionality. For example, neckband 330 may allow components that would otherwise be included on an eyewear device to be included in neckband 330 since users may tolerate a heavier weight load on their shoulders than they would tolerate on their heads. Neckband 330 may also have a larger surface area over which to diffuse and disperse heat to the ambient environment. Thus, neckband 330 may allow for greater battery and computation capacity than might otherwise have been possible on a stand-alone eyewear device. Since weight carried in neckband 330 may be less invasive to a user than weight carried in eyewear device 305, a user may tolerate wearing a lighter eyewear device and carrying or wearing the paired device for greater lengths of time than a user would tolerate wearing a heavy standalone eyewear device, thereby enabling users to more fully incorporate extended reality environments into their day-to-day activities.

Neckband 330 may be communicatively coupled with eyewear device 305 and/or to other devices. These other devices may provide certain functions (e.g., tracking, localizing, depth mapping, processing, storage, etc.) to augmented reality system 300. In the embodiment of FIG. 3A, neckband 330 may include two acoustic transducers (e.g., 325(I) and 325(J)) that are part of the microphone array (or potentially form their own microphone subarray). Neckband 330 may also include a controller 342 and a power source 345.

Acoustic transducers 325(I) and 325(J) of neckband 330 may be configured to detect sound and convert the detected sound into an electronic format (analog or digital). In the embodiment of FIG. 3A, acoustic transducers 325(I) and 325(J) may be positioned on neckband 330, thereby increasing the distance between the neckband acoustic transducers 325(I) and 325(J) and other acoustic transducers 325 positioned on eyewear device 305. In some cases, increasing the distance between acoustic transducers 325 of the microphone array may improve the accuracy of beamforming performed via the microphone array. For example, if a sound is detected by acoustic transducers 325(C) and 325(D) and the distance between acoustic transducers 325(C) and 325(D) is greater than, e.g., the distance between acoustic transducers 325(D) and 325(E), the determined source location of the detected sound may be more accurate than if the sound had been detected by acoustic transducers 325(D) and 325(E).

Controller 342 of neckband 330 may process information generated by the sensors on neckband 330 and/or augmented reality system 300. For example, controller 342 may process information from the microphone array that describes sounds detected by the microphone array. For each detected sound, controller 342 may perform a direction-of-arrival (DOA) estimation to estimate a direction from which the detected sound arrived at the microphone array. As the microphone array detects sounds, controller 342 may populate an audio data set with the information. In embodiments in which augmented reality system 300 includes an inertial measurement unit, controller 342 may compute all inertial and spatial calculations from the IMU located on eyewear device 305. A connector may convey information between augmented reality system 300 and neckband 330 and between augmented reality system 300 and controller 342. The information may be in the form of optical data, electrical data, wireless data, or any other transmittable data form. Moving the processing of information generated by augmented reality system 300 to neckband 330 may reduce weight and heat in eyewear device 305, making it more comfortable to the user.

Power source 345 in neckband 330 may provide power to eyewear device 305 and/or to neckband 330. Power source 345 may include, without limitation, lithium-ion batteries, lithium-polymer batteries, primary lithium batteries, alkaline batteries, or any other form of power storage. In some cases, power source 345 may be a wired power source. Including power source 345 on neckband 330 instead of on eyewear device 305 may help better distribute the weight and heat generated by power source 345.

As noted, some extended reality systems may, instead of blending an extended reality with actual reality, substantially replace one or more of a user's sensory perceptions of the real world with a virtual experience. One example of this type of system is a head-worn display system, such as virtual reality system 350 in FIG. 3B, that mostly or completely covers a user's field of view. Virtual reality system 350 may include a front rigid body 355 and a band 360 shaped to fit around a user's head. Virtual reality system 1700 may also include output audio transducers 365(A) and 365(B). Furthermore, while not shown in FIG. 3B, front rigid body 355 may include one or more electronic elements, including one or more electronic displays, one or more inertial measurement units (IMUs), one or more tracking emitters or detectors, and/or any other suitable device or system for creating an extended reality experience.

Extended reality systems may include a variety of types of visual feedback mechanisms. For example, display devices in augmented reality system 300 and/or virtual reality system 350 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. These extended reality systems may include a single display screen for both eyes or may provide a display screen for each eye, which may allow for additional flexibility for varifocal adjustments or for correcting a user's refractive error. Some of these extended reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the extended reality systems described herein may include one or more projection systems. For example, display devices in augmented reality system 300 and/or virtual reality system 350 may include micro-LED projectors that project light (using, e.g., a waveguide) into display devices, such as clear combiner lenses that allow ambient light to pass through. The display devices may refract the projected light toward a user's pupil and may enable a user to simultaneously view both extended reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Extended reality systems may also be configured with any other suitable type or form of image projection system, such as retinal projectors used in virtual retina displays.

The extended reality systems described herein may also include various types of computer vision components and subsystems. For example, augmented reality system 300 and/or virtual reality system 350 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An extended reality system may process data from one or more of these sensors to identify a location of a user, to map the real world, to provide a user with context about real-world surroundings, and/or to perform a variety of other functions.

The extended reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the extended reality systems described herein may also include tactile (e.g., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other extended reality devices, within other extended reality devices, and/or in conjunction with other extended reality devices.

By providing haptic sensations, audible content, and/or visual content, extended reality systems may create an entire virtual experience or enhance a user's real-world experience in a variety of contexts and environments. For instance, extended reality systems may assist or extend a user's perception, memory, or cognition within a particular environment. Some systems may enhance a user's interactions with other people in the real world or may enable more immersive interactions with other people in a virtual world. Extended reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's extended reality experience in one or more of these contexts and environments and/or in other contexts and environments.

As noted, extended reality systems 300 and 350 may be used with a variety of other types of devices to provide a more compelling extended reality experience. These devices may be haptic interfaces with transducers that provide haptic feedback and/or that collect haptic information about a user's interaction with an environment. The extended reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

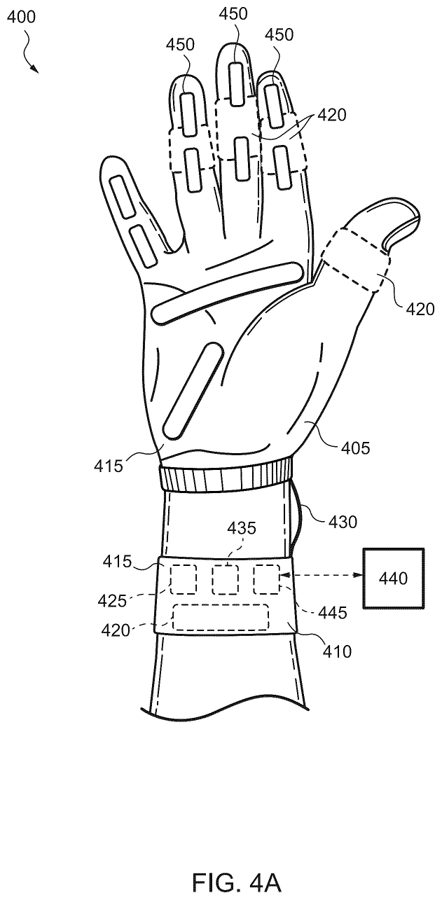

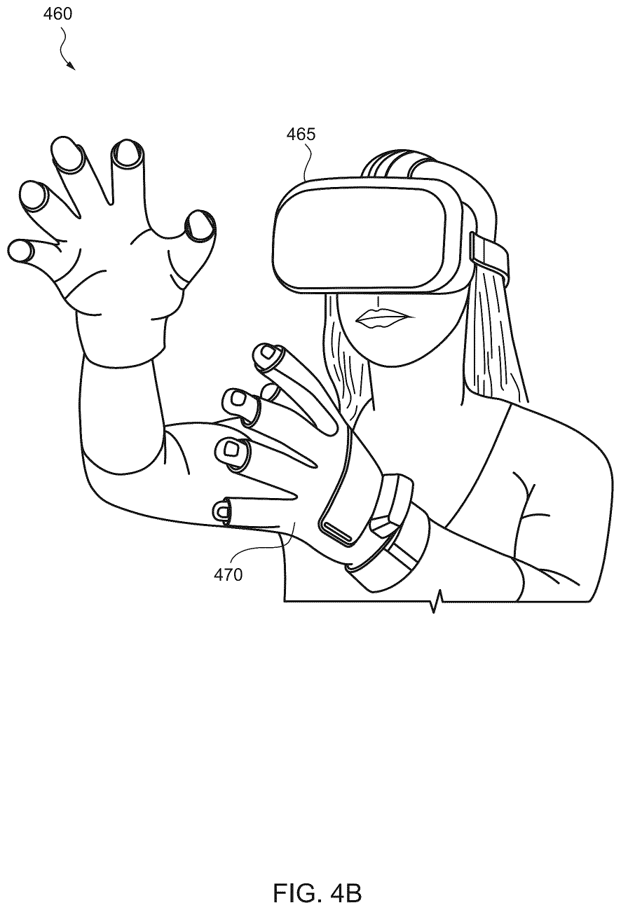

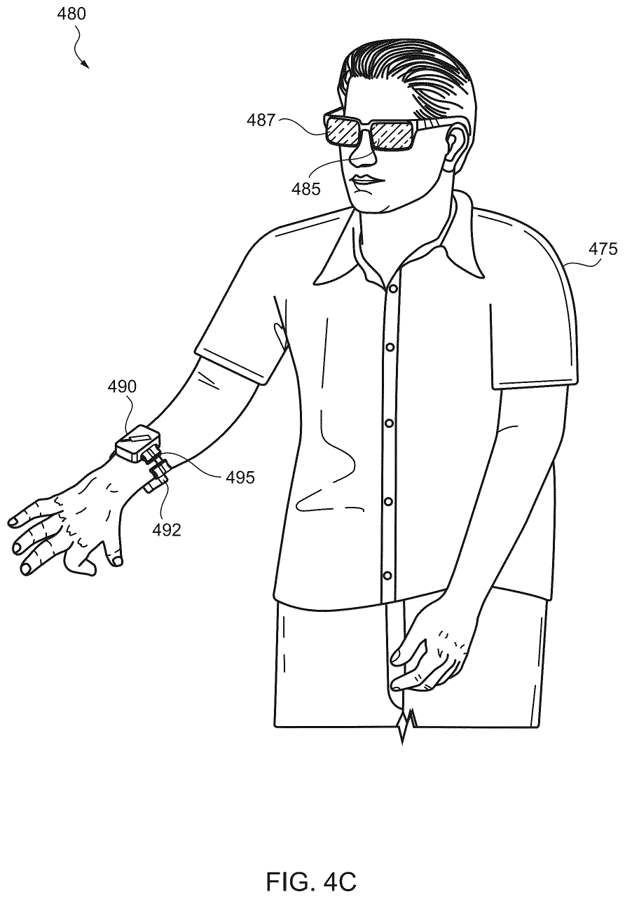

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 4A illustrates a vibrotactile system 400 in the form of a wearable glove (haptic device 405) and wristband (haptic device 410). Haptic device 405 and haptic device 410 are shown as examples of wearable devices that include a flexible, wearable textile material 415 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 420 may be positioned at least partially within one or more corresponding pockets formed in textile material 415 of vibrotactile system 400. Vibrotactile devices 420 may be positioned in locations to provide a vibrating sensation (e.g., haptic feedback) to a user of vibrotactile system 400. For example, vibrotactile devices 420 may be positioned against the user's finger(s), thumb, or wrist, as shown in FIG. 4A. Vibrotactile devices 420 may, in some examples, be sufficiently flexible to conform to or bend with the user's corresponding body part(s).

A power source 425 (e.g., a battery) for applying a voltage to the vibrotactile devices 420 for activation thereof may be electrically coupled to vibrotactile devices 420, such as via conductive wiring 430. In some examples, each of vibrotactile devices 420 may be independently electrically coupled to power source 425 for individual activation. In some embodiments, a processor 435 may be operatively coupled to power source 425 and configured (e.g., programmed) to control activation of vibrotactile devices 420.

Vibrotactile system 400 may be implemented in a variety of ways. In some examples, vibrotactile system 400 may be a standalone system with integral subsystems and components for operation independent of other devices and systems. As another example, vibrotactile system 400 may be configured for interaction with another device or system 440. For example, vibrotactile system 400 may, in some examples, include a communications interface 445 for receiving and/or sending signals to the other device or system 440. The other device or system 440 may be a mobile device, a gaming console, an extended reality (e.g., virtual reality, augmented reality, mixed-reality) device, a personal computer, a tablet computer, a network device (e.g., a modem, a router, etc.), a handheld controller, etc. Communications interface 445 may enable communications between vibrotactile system 400 and the other device or system 440 via a wireless (e.g., Wi-Fi, Bluetooth, cellular, radio, etc.) link or a wired link. If present, communications interface 445 may be in communication with processor 435, such as to provide a signal to processor 435 to activate or deactivate one or more of the vibrotactile devices 420.

Vibrotactile system 400 may optionally include other subsystems and components, such as touch-sensitive pads 450, pressure sensors, motion sensors, position sensors, lighting elements, and/or user interface elements (e.g., an on/off button, a vibration control element, etc.). During use, vibrotactile devices 420 may be configured to be activated for a variety of different reasons, such as in response to the user's interaction with user interface elements, a signal from the motion or position sensors, a signal from the touch-sensitive pads 450, a signal from the pressure sensors, a signal from the other device or system 440, etc.

Although power source 425, processor 435, and communications interface 445 are illustrated in FIG. 4A as being positioned in haptic device 410, the present disclosure is not so limited. For example, one or more of power source 425, processor 435, or communications interface 445 may be positioned within haptic device 405 or within another wearable textile.

Haptic wearables, such as those shown in and described in connection with FIG. 4A, may be implemented in a variety of types of extended reality systems and environments. FIG. 4B shows an example extended reality environment 460 including one head-mounted virtual reality display and two haptic devices (e.g., gloves), and in other embodiments any number and/or combination of these components and other components may be included in an extended reality system. For example, in some embodiments there may be multiple head-mounted displays each having an associated haptic device, with each head-mounted display and each haptic device communicating with the same console, portable computing device, or other computing system.

HMD 465 generally represents any type or form of virtual reality system, such as virtual reality system 350 in FIG. 3B. Haptic device 470 generally represents any type or form of wearable device, worn by a user of an extended reality system, that provides haptic feedback to the user to give the user the perception that he or she is physically engaging with a virtual object. In some embodiments, haptic device 470 may provide haptic feedback by applying vibration, motion, and/or force to the user. For example, haptic device 470 may limit or augment a user's movement. To give a specific example, haptic device 470 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 470 to send action requests to a console. Examples of action requests include, without limitation, requests to start an application and/or end the application and/or requests to perform a particular action within the application.

While haptic interfaces may be used with virtual reality systems, as shown in FIG. 4B, haptic interfaces may also be used with augmented reality systems, as shown in FIG. 4C. FIG. 4C is a perspective view of a user 475 interacting with an augmented reality system 480. In this example, user 475 may wear a pair of augmented reality glasses 485 that may have one or more displays 487 and that are paired with a haptic device 490. In this example, haptic device 490 may be a wristband that includes a plurality of band elements 492 and a tensioning mechanism 495 that connects band elements 492 to one another.

One or more of band elements 492 may include any type or form of actuator suitable for providing haptic feedback. For example, one or more of band elements 492 may be configured to provide one or more of various types of cutaneous feedback, including vibration, force, traction, texture, and/or temperature. To provide such feedback, band elements 492 may include one or more of various types of actuators. In one example, each of band elements 492 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 405, 410, 470, and 490 may include any suitable number and/or type of haptic transducer, sensor, and/or feedback mechanism. For example, haptic devices 405, 410, 470, and 490 may include one or more mechanical transducers, piezoelectric transducers, and/or fluidic transducers. Haptic devices 405, 410, 470, and 490 may also include various combinations of different types and forms of transducers that work together or independently to enhance a user's extended reality experience. In one example, each of band elements 492 of haptic device 490 may include a vibrotactor (e.g., a vibrotactile actuator) configured to vibrate in unison or independently to provide one or more of various types of haptic sensations to a user.

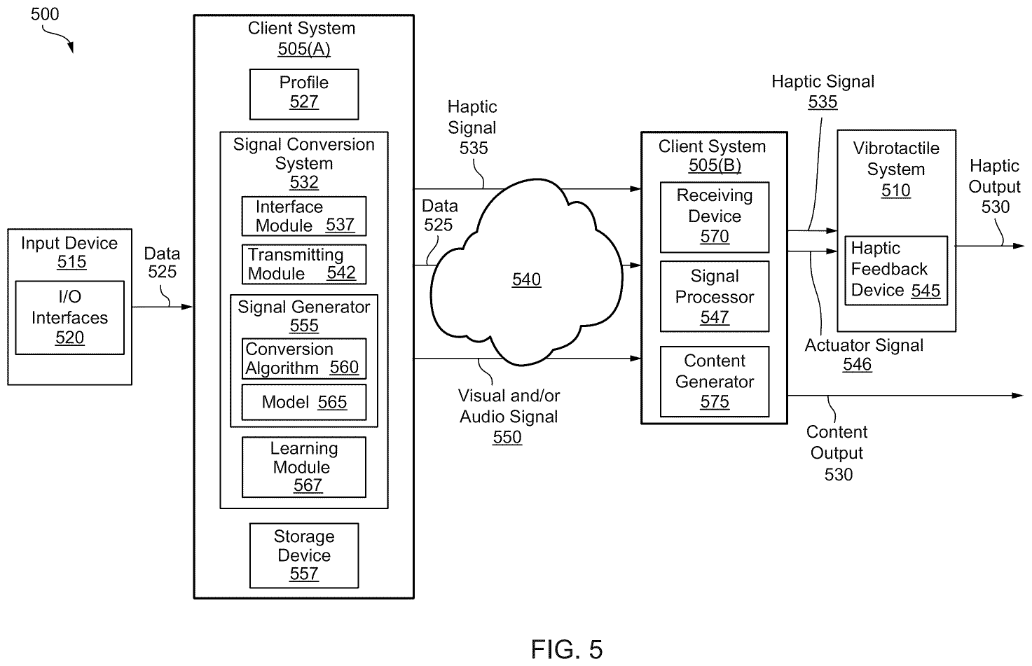

FIG. 5 is a block diagram of a social communication platform 500. In various embodiments, the social communication platform 500 is implemented in software, hardware, or a combination thereof that facilitates touch communication with users. The social communication platform 500 is instantiated using a client system 505(a-n) associated with each user (e.g., the client system 105 as described with respect to FIG. 1) and a vibrotactile system 510 (e.g., vibrotactile system 400 as described with respect to FIGS. 4A-4C) to convey messages (including visual and/or audible messages) using the sense of touch to a user's body. The social communication platform 500 communicates the sense of touch in the form of haptic output generated by a haptic feedback device of vibrotactile system 510 attached to a user's body. To generate the haptic output, a message from a first user (sending user) is processed by an algorithm to generate a corresponding haptic signal that is transmitted to a second user (receiving user) to operate the haptic feedback device. The haptic feedback device receives the transmitted haptic signals, translates the haptic signals into the haptic output, and transmits the haptic output corresponding to the received haptic signals to a body of the second user.

The first user may be a human user or an artificial system such as a virtual assistant (e.g., virtual assistant engine 110). A message to be communicated to a second user is generated by the first user using one or more input devices 515 such as a keyboard, game controllers, display devices, image capture sensors, HMDs, haptic sensors, and the like. The one or more input devices 515 include one or more I/O interfaces 520, which allow for communicating with the one or more input devices 515. The one or more I/O interfaces 520 may include one or more wired or wireless network interface controllers (NICs) for communicating with a network, such as network 120 described with respect to FIG. 1. The one or more I/O interfaces 520 may be visual interfaces associated with mechanical devices (e.g., a keyboard or controller) or virtual devices (e.g., a graphical user interface), non-visual interfaces associated with sensors (e.g., optical sensors, haptic sensors, or audio sensors), or a combination thereof. For example, a first user may choose to send a text message to a second user via a keypad on their tablet, and the message is at least partially communicated to the second user via haptic output 530. Alternatively, a first user may choose to send a text message with a visual emoji to a second user via a keypad on their phone, and the text message and visual emoji is at least partially communicated to the second user via haptic output 530. Alternatively, a first user may choose to send a touch message via a mental model or gesture, and the touch message is communicated to the second user via haptic output 530. Alternatively, a first user may choose to send a touch message via haptic touching, and the touch message is communicated to the second user via haptic output 530. Alternatively, a first user may choose to send a touch message as an auto generated or semi-auto generated response to a received communication and/or perceived context, and the touch message is communicated to the second user via haptic output 530.

Data 525 pertaining to the message is obtained using the one or more I/O interfaces 520. For example, the first user may be wearing a smart watch with a graphical user interface (an input device 520). The first user may send emojis to users as a form of messaging via the graphical user interface. The emojis are data (data 525) that may have a visual component and/or an audio component. Alternatively, the first user may be wearing an HMD with sensors (an input device 520). The first user may speak and/or perform gestures with their hands that is captured by audio sensors and/or optical sensors. The audio and/or gestures may have a pattern associated with a message such as saying hello, or a waving gesture may be associated with a greeting to another user. The sensors may convert the captured audio or images into sensor signals (data 525) including electronic signals representative of sounds and its characteristics and/or light and its characteristics. Alternatively, the first user may be wearing a device such as a glove with haptic sensors (an input device 520). The first user's body may transmit haptic touches to the haptic sensors. The haptic sensors may convert the haptic touches to sensor signals (data 525) including current, voltage, pressure, some other type of sensor signal, or a combination thereof.

In some embodiments, the data 525 obtained via the client system 505 is associated with one or more privacy settings. The data 525 may be stored on or otherwise associated with any suitable computing system or application, such as, for example, a social-networking system, a client system, a third-party system, a messaging application, a photo-sharing application, a biometric data acquisition application, an artificial-reality application, a virtual assistant application, and/or any other suitable computing system or application.

Privacy settings (or “access settings”) for the data 525 may be stored in any suitable manner; such as, for example, in association with data 525, in an index on an authorization server, in another suitable manner, or any suitable combination thereof. A privacy setting for data 525 may specify how the data 525 (or particular information associated with the data 525) can be accessed, stored, or otherwise used (e.g., viewed, shared, modified, copied, executed, surfaced, or identified) within an application (such as an extended reality application). When privacy settings for the data 525 allow a particular user or other entity to access that the data 525, the data 525 may be described as being “visible” with respect to that user or other entity. As an example, a user of an extended reality application or virtual assistant application may specify privacy settings for a user profile 527 page that identify a set of users that may access the extended reality application or virtual assistant application information on the user profile 527 page, thus excluding other users from accessing that information. As another example, an extended reality application or virtual assistant application may store privacy policies/guidelines. The privacy policies/guidelines may specify what information of users may be accessible by which entities and/or by which processes (e.g., internal research, advertising algorithms, machine-learning algorithms), thus ensuring only certain information of the user may be accessed by certain entities or processes.

In some embodiments, privacy settings for the data 525 may specify a “blocked list” of users or other entities that should not be allowed to access certain information associated with the data 525. In some cases, the blocked list may include third-party entities. The blocked list may specify one or more users or entities for which the data 525 is not visible.

Privacy settings associated with the data 525 may specify any suitable granularity of permitted access or denial of access. As an example, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. In some embodiments, different pieces of the data 525 of the same type associated with a user may have different privacy settings. In addition, one or more default privacy settings may be set for each piece of data 525 of a particular data-type.

The data 525 is processed by a signal conversion system 532 of the client system 505 in order to generate a haptic signal 535 corresponding to at least a portion of the message. The signal conversion system 532 is connected to the I/O interfaces 520 and includes an interface module 537 for receiving the data 525 from the I/O interfaces 520. The signal conversion system 532 is also connected to a network 540, which may include any combination of local area and/or wide area networks, using both wired and/or wireless communication systems. The signal conversion system 532 includes transmitting module 542 for sending a haptic signal 535 to a recipient of the message (e.g., the receiving user) via the network 540. In some instances, the haptic signal 535 is transmitted to a haptic feedback device 545 (e.g., an array of actuators) placed on a receiving user's body to cause the haptic feedback device 545 to create tactile sensation along the body of the receiving user. In other instances, the haptic signal 535 is transmitted to a signal processor 547 within the client system 505(b) of the receiving user to convert the haptic signal 535 to one or more actuator signals 546, which are transmitted to a haptic feedback device 545 (e.g., an array of actuators) placed on a receiving user's body to cause the haptic feedback device 545 to create tactile sensation along the body of the receiving user. In other instances, the haptic signal 535 is transmitted to a signal processor 547 within the client system 505(b) of the receiving user to adjust the haptic signal 535 or the one or more actuator signals 546 before one or the other is transmitted to the body of the receiving user via the haptic feedback device 545. Alternatively or in addition to sending the haptic signal 535, the transmitting module 545 may send the data 525 and/or at least a portion of the message as a visual and/or audio signal 550 (e.g., a visual emoji with sound effect).

The signal conversion system 532 further includes a signal generator 555 to generate the haptic signal 535 based on the data 525. The haptic signal 535 may be generated from data 525 using one or more signal processing techniques, as described herein in detail. In some instances, a lexicon of emojis is stored in a storage device 557 that is searchable based on the data 525. For example, a first user may activate a key or button of a user interface or utilize a mental model and gesture associated with a “ahem” emoji, and the signal generator searches the lexicon of emojis for the “ahem” emoji. Each emoji may have predefined audio assets, haptic assets, visual assets, or a combination thereof. By way of another example, a first user may activate keys or buttons of a user interface to type in hello, or speak hello, or gesture hello, and the signal generator searches the lexicon of emojis for the word “hello”. Each communication phrase or word may have predefined audio assets, haptic assets, visual assets, or a combination thereof. The haptic assets comprise the haptic signal 535. In other instances, the signal generator 555 may comprise a conversion algorithm 560 for converting the data 525 to the haptic signal 535. The conversion algorithm 560 may be embodied as a transfer function (also known as a transfer curve) that is a mathematical representation for fitting or describing the mapping of the data 525 to the haptic signal 535. The transfer function may be a representation in terms of spatial or temporal frequency, of the relation between the input and output of the signals in data 525 to haptic signal 535 mapping system with zero initial conditions and zero-point equilibrium. In other instances, the signal generator 555 may comprise one or more rule based or machine-learning based models 565 for extracting features from the data 525, inferring a touch communication signal within the data 525 based on the extracted features, and generating the haptic signal 535 based on the inferred touch communication signal. The haptic signal 535 may include parameter information on interval, pitch, amplitude, or a combination thereof for a touch message to be perceived by a receiving user's body. These parameters may be used by the haptic feedback device 545 to generate haptic output 530 corresponding to the parameters received by the haptic feedback device 545. For example, the parameters may be translated by the haptic feedback device 545 into a duration time, frequency, or amplitude of the haptic output 530.

The signal conversion system 532 may further include a learning module 567 to generate a learning program based on the data 525, the haptic signal 535, the visual and/or audio signal 550, or a combination thereof. The learning program may promote immersive, age-independent, IQ-independent, and subconscious learning of the meaning of a haptic output 530 by a user. The benefits and advantages of this approach are that the receiving user may more easily learn the haptic output patterns and associated meaning based on associated visual and/or audio context. For example, the learning module 585 may be configured to transmit via transmitting module 542 the haptic signal 535 along with a visual and/or audio signal 550 to the receiving user such that when the user feels the haptic output 530 based on the haptic signal 535 the user concurrently visualizes on a display the visual signal 550 (e.g., a visual emoji) and/or hears the audio signal 550, the user learns to associate the haptic output pattern with an associated visual and/or audio context. The visual and/or audio signal 550 may be received as part of the data 525, and associated and transmitted with the haptic signal 535 by the learning module 567 and transmitting module 542. Additionally or alternatively, the visual and/or audio signal 550 may be generated based on the data 525 by the learning module 567, and associated and transmitted with the haptic signal 535 by the learning module 567 and transmitting module 542.

The client system 505(b) of the receiving user includes a receiving device 570 that receives the data 525, the haptic signal 535, the visual and/or audio signal 550, or any combination thereof from the transmitting module 542 over the network 540 and routes the data 525, the haptic signal 535, the visual and/or audio signal 550, or any combination thereof to the signal processor 547, a content generator 575, the vibrotactile system 510, or a combination thereof. The signal processor 547 may generate a haptic signal 535 (as similarly discussed with respect to signal generator 555 based on data 525), generate one or more actuator signals 546, and/or modify a haptic signal 535 or one or more actuator signals 546 (e.g., to customize a signal based on the receiving user's preferences). The signal processor 547 transmits the original or modified haptic signal 535 or one or more actuator signals 546 to the vibrotactile system 510. The content generator 575 generates content output 580 for the receiving user based on the visual and/or audio signal 550 (e.g., generates a graphic display for a visual emoji to be visualized by the receiving user). In some instances, the vibrotactile system 510 receives the haptic signal 535 and uses the haptic feedback device 545 to transmit haptic output 530 (e.g., vibrations) corresponding to the received haptic signal 535 to a body of the receiving user. In other instances, vibrotactile system 510 converts the haptic signal 535 into one or more actuator signals 546 and uses the haptic feedback device 545 to transmit haptic output 530 (e.g., vibrations) corresponding to the one or more actuator signals 546 to a body of the receiving user. In either instance, cutaneous actuators may transmit the haptic output 530 to C tactile (CT) afferent nerve fibers of the body of the receiving user. In the peripheral nervous system (PNS), a CT afferent nerve fiber is the axon of a sensory neuron. The CT afferent nerve fiber carries an action potential from the sensory neuron toward the central nervous system (CNS).

Although the social communication platform 500 is described with regard to generating the haptic signal 535 at the client system 505(a) of the sending user, it should be understood that the haptic signal 535 can alternatively be generated at the client system 505(b) of the receiving user or a completely different remote system (e.g., a distributed social networking system) using similar components and techniques described herein. Moreover, the social communication platform 500 illustrates a one-way haptic communication where the sending user sends a haptic signal to the receiving user, however it should be understood that the haptic communication can be bidirectional and the client system 505(b) of the receiving user could have similar components as described with respect to the client system 505(a) of the sending user and likewise the client system 505(a) of the sending user could have similar components as described with respect to the client system 505(b) of the receiving user. Further, a sending user can broadcast the haptic signal via network 540 to a plurality of client systems 505(b-n) associated with receiving users instead of a single receiving user.

### Touch Communication Techniques

As discussed herein, there are various techniques that may be used by the sending user to send a touch communication. For example, a first user may choose to send a text message to a second user via a keypad on their tablet, and the message is at least partially communicated to the second user via haptic output. Alternatively, a first user may choose to send a text message with a visual emoji to a second user via a keypad on their phone, and the text message and visual emoji is at least partially communicated to the second user as a touch message via haptic output. Alternatively, a first user may choose to send a touch message via a mental model or gesture, and the touch message is communicated to the second user via haptic output. Alternatively, a first user may choose to send a touch message via haptic touching, and the touch message is communicated to the second user via haptic output. Alternatively, a first user may choose to send a touch message as an auto generated or semi-auto generated response to a received communication and/or perceived context, and the touch message is communicated to the second user via haptic output. The following describes details for implementing these various touch communication techniques.

### Touch Communication Using a Lexicon of Emojis

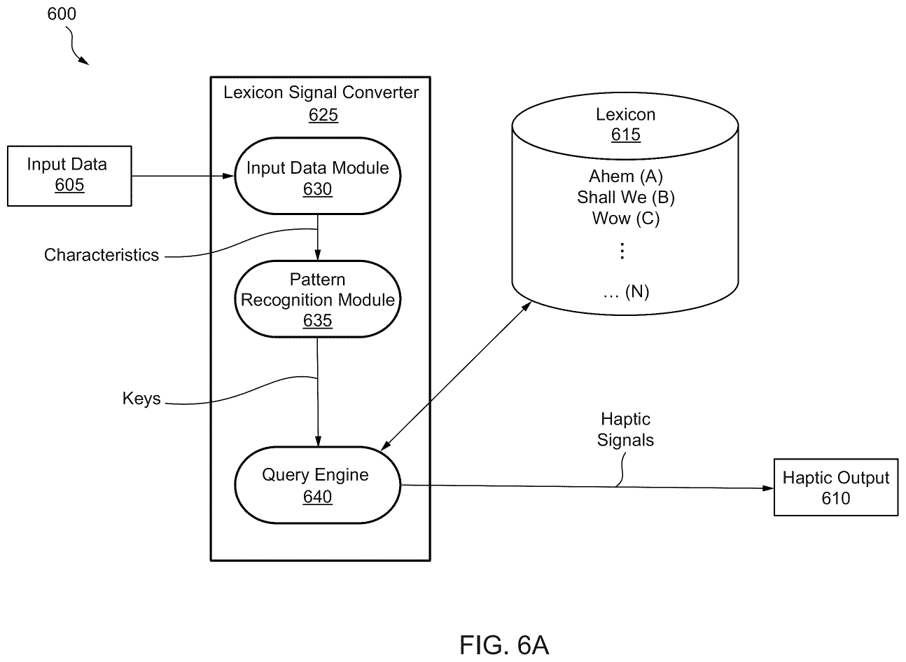

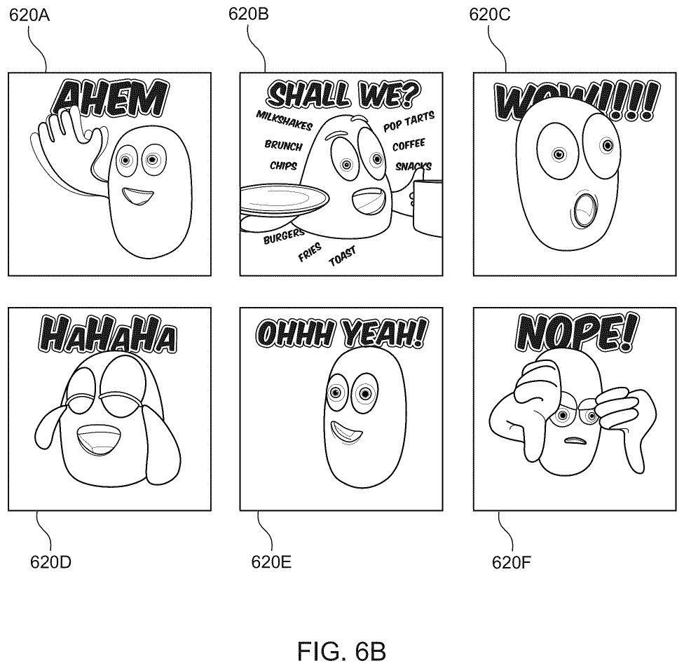

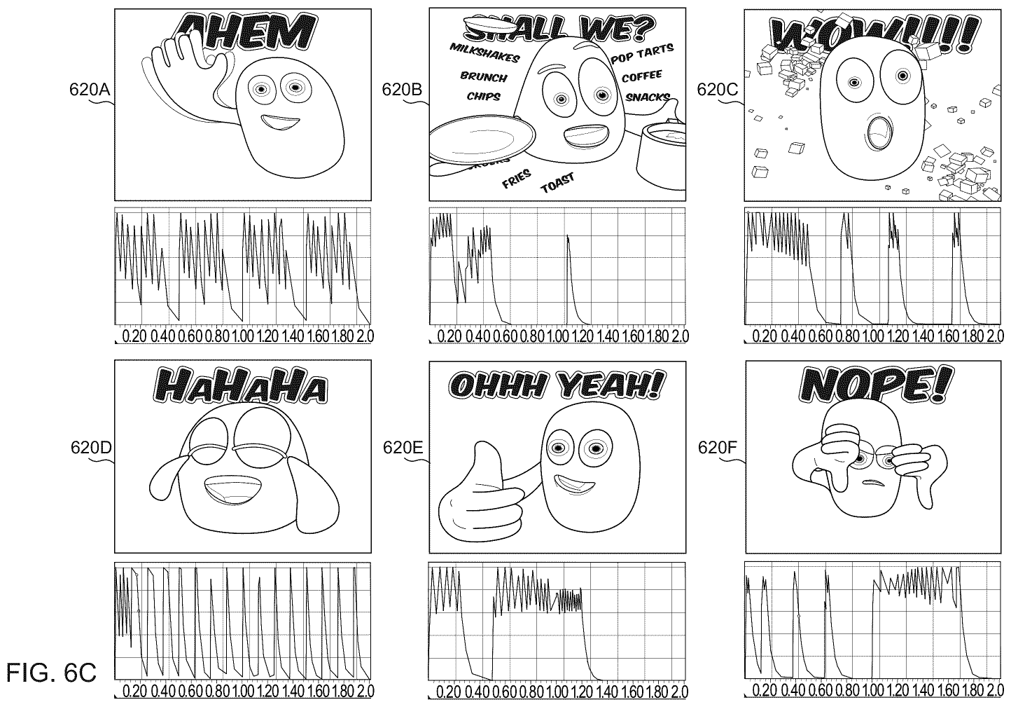

FIG. 6A is a block diagram illustrating components of a social communication system 600 for converting input data 605 to haptic output 610 using a lexicon of emojis 615 in accordance with various embodiments. To generate the haptic output 610, input data 605 from a first user (sending user) is processed by an algorithm using the lexicon of emojis 615 to obtain a corresponding haptic signal that is transmitted to a second user (receiving user) to operate the haptic feedback device. The haptic feedback device receives the transmitted haptic signals, translates the haptic signals into the haptic output 610, and transmits the haptic output 610 corresponding to the received haptic signals to a body of the second user.

The input data 605 may be text, audio, images or video, sensor data, or the like. For example, a first user may send emojis to users as a form of messaging via a graphical user interface or web browser. The emojis are input data that may have an image component and/or an audio component. Alternatively, a first user may send text to users as a form of messaging via a graphical user interface or web browser. The text is input data (e.g., an emoticon, initialism, or words corresponding to an emotion). Alternatively, a first user may speak and/or perform gestures with their hands that is captured by audio and/or image sensors. For example, a user may choose to send a touch message without a visual interface such as via a mental model and gestures (the user knows positions of contacts on their wrist and knows thumbs up is one emote and can use gestures to send the touch message). By way of another example, one or more quick gestures could be used for responses to a given context (e.g., receipt of a text message). The sensors may convert the captured audio or images into sensor data (input data) including electronic signals representative of sounds and its characteristics and/or light and its characteristics. Alternatively, a first user's body may transmit haptic touches to haptic sensors. The haptic sensors may convert the haptic touches to sensor signals (input data) including current, voltage, pressure, some other type of sensor signal, or a combination thereof.

In some instances, the lexicon of emojis 615 may be key-value store, or key-value database, which is a type of data storage software program that stores data as a set of unique identifiers, each of which have an associated value. This data pairing is known as a “key-value pair.” The unique identifier is the “key” for an item of data, and a value is either the data being identified or the location of that data. Although, the lexicon of emojis 615 is described herein as a key-value database it should be understood that other database designs could be used without departing from the spirit and scope of the present disclosure. For example in other instances, the lexicon of emojis 615 is a relational database, where data is stored in tables composed of rows and columns. The database developer specifies attributes of the data (i.e., emojis and assets thereof) to be stored in the table upfront. This creates significant opportunities for optimizations such as data compression and performance around aggregations and data access. The attributes of the data may be queried in a similar fashion as keys in the key-value database to identify emojis associated with such attributes.

The lexicon of emojis 615 comprises various emojis that can be used for electronic communication including touch communication. Each emoji in the lexicon of emojis 615 or the location of the emoji is a value associated with a key that can be queried via the input data 605. The keys may be in several forms depending on the various type of input data accepted by the social communication system 600 for converting input data 605 to haptic output 610. For example, the keys may include images, natural language terms, or audio patterns (e.g., words, phrases, slang, chat, or the like such as hello, good bye, thank you, I love you, wow, ahem, LOL, HaHaHa, Ohhh Yea, OK, nope, yes, and the like), and each image, term, or audio pattern is associate with a particular emoji. Additionally or alternatively, the keys may include gesture or haptic patterns (wave, pat, hug, pinch, touch, brush, shake, push, clap, etc.), and each gesture or haptic pattern is associate with a particular emoji. As should be understood, one or more keys may be associated with each emoji. For example, the natural language word “hello”, an image of a welcome emoji, an audio pattern for saying “hello” in natural language, and a gesture pattern for waving “hello” may all be associated with a “hello” emoji within the lexicon of emojis 615.

The lexicon of emojis 615 may comprises any number of emojis 620 (A-N). Each of the emojis 620 is configured with a corresponding electronic communication that includes a visual component (shown in FIG. 6B as the character in each illustration), an audio component (shown in FIG. 6B as the verbal utterance in each illustration), a haptic component (shown in FIG. 6C as the haptic signal pattern in each illustration), or a combination thereof. Emojis with a visual component (e.g., a pictogram, logogram, or ideogram) are associated within the lexicon to an image or video asset (e.g., a jpeg, gif, mov, or j son file). Emojis with an audio component are associated within the lexicon to an audio asset (e.g., a way or mp3 file). Emojis with a haptic component are associated within the lexicon to a haptic signal (e.g., parameter information on interval, pitch, amplitude, or a combination thereof for a touch message to be perceived by a receiving user's body), which can be converted into haptic output 615.

The haptic signal for each emoji may be pre-generated. In some instances, the haptic signal is configured with parameter information for interval, pitch, and amplitude to generate patterns for the haptic output 610 that match the image or animation of the emoji and/or the sound effect of the emoji (i.e., the image or audio component supplement the understanding of the haptic component). In other instances, the haptic signal is configured with parameter information determined by a user (e.g., a perceptual scientist) to generate patterns for the haptic output 610 that best communicate the emotion to a user (i.e., the haptic component has a high likelihood of conveying the emotion to a user without the image or audio component). In other instances, the haptic signal is configured with parameter information determined by a user (e.g., a user of the HMD device) to generate patterns for the haptic output 610 that customize touch communicate to a user (i.e., the haptic component is customized for conveying the emotion to a user with or without the image or audio component).

A lexicon signal converter 625 converts the input data 605 into haptic signals 610 using the lexicon of emojis 615. The lexicon signal converter 620 may be a component in a signal generator (e.g., signal generator 555 described with respect to FIG. 5). The lexicon signal converter 620 comprises an input data processing module 630, a pattern recognition module 635, and a query engine 640. The input processing module 625 determines the characteristics of the input data 605 received (e.g., text, audio, images or video, sensor data, or the like) using the input data module 630, identifies a key or attributes within the input data 605 using the pattern recognition module 635, and communicates the key or attributes to the query engine 640 for searching the lexicon of emojis 615 to identify one or more emojis associated with an electronic communication.

The characteristics of the input data 605 may be determined by the input data module 630 based on the I/O interfaces communicating the input data 605 to the lexicon signal converter 620. In some instances, labels or metadata may be created by the controller of the input device when generating the input data 605 and the labels or metadata are a characteristic used to identify one or more emojis associated with an electronic communication. For example, if the input data 605 received is generated by a first user selecting a LOL visual emoji on a graphical user interface or web browser, the firmware or software for the input device may be configured to automatically label the input data 605 associated with the LOL visual emoji. In some instances, the type of data created by the controller of the input device when generating the input data 605 is a characteristic used to identify one or more emojis associated with an electronic communication. For example, if the I/O interface communicating the input data 605 are associated with a mechanical keyboard then a type of data may be determined to be text data, if the I/O interface is associate with optical sensors then a type of data may be determined to be images or video, if the I/O interface is associate with a microphone or audio sensor then the type of data may be determined to be audio, etc.

Once the characteristics (e.g., metadata, labels, type, etc.) of input data 605 are determined, pattern recognition module 635 can process the input data 605 based on the characteristics to identify patterns within the input data 605 that correspond to a key or attributes associated with an emoji. In some instances, the key or attributes are identified within the input data 605 based on the labels or metadata associated with the input data 605. The identifying may be performed by recognizing known headers or pointers within the labels or metadata that specify a key. In other instances, a key or attributes are identified within the input data 605 by analyzing the input data 605. The analyzing performed may be specific to the type of data received and in general may comprise parsing the input data (e.g., converting a analog signal to a digital signal or converting raw HTML to XML), removing noise from the input data (e.g., removing background noise or dead space from an audio signal or video signal), converting the input data from one type of data to another type of data (e.g., audio or video data may be transformed to text data using an audio or video transcriber), normalizing and/or standardizing the input data, identifying patterns with the input data associated with a key or attributes, isolating portions of the input data (e.g., isolating portions that have patterns that could be associated with a key or attributes), or any combination thereof. For example, if the input data 605 received includes a first user speaking “Tell Mandy—John's actions in that meeting were completely off point LOL”, the input data processing module 630 may first determine that the input data 605 is an audio signal based on the I/O interface communicating the input data 605 being associated with the first user's microphone. Second, the input data processing module 630 may remove background noise or dead space from the audio signal and transcribe the denoised audio signal to text. Third, the pattern recognition module 635 may identify “actions” and “LOL” as keys or attributes based on pattern recognition for the type of data and isolate the terms (“actions” and “LOL”) as keys or attributes from the text.

Once the pattern recognition module 635 has identified the keys or attributes, the pattern recognition module 635 communicates the keys or attributes (e.g., “actions” and “LOL”) to the query engine 640 for obtaining one or more emojis associated with the key or attributes. The query engine 640 obtains one or more emojis associated with a key by specifying a get or read operation using the identified key (and optionally a namespace). The get or read operation returns the value for a given key if it exists (the value being the emoji and associated assets). The query engine 640 obtains one or more emojis associated with attributes by specifying parameters for a query, select, extract, read, or the like operation using the identified attributes. The query, select, extract, read, or the like operation returns the value based on the attributes if it exists (the value being the emoji and associated assets). Although the above description is specific to identify the key or attributes associated with a single haptic emoji, it should be understood that users could sequence emoji's together to send more complex messages, and thus the input data may actually result in the identification of multiple keys or attributes in sequence associated with multiple emojis to be conveyed in sequence via haptic output to a user's body.

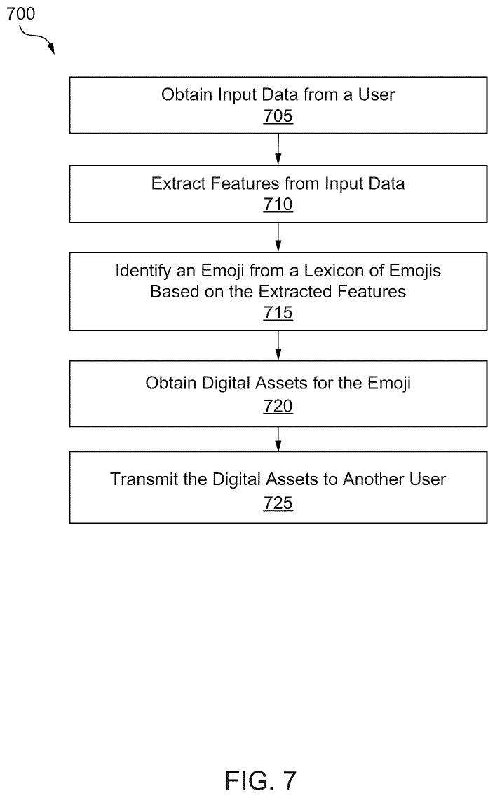

FIG. 7 is a flowchart illustrating a process 700 for converting input data to haptic output using a lexicon of emojis according to various embodiments. The processing depicted in FIG. 7 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 7 and described below is intended to be illustrative and non-limiting. Although FIG. 7 depicts the various processing steps occurring in a particular sequence or order, this is not intended to be limiting. In certain alternative embodiments, the steps may be performed in some different order or some steps may also be performed in parallel. In certain embodiments, such as in an embodiment depicted in FIG. 1, 2A, 2B, 3A, 3B, 4A, 4B, 4C, 5, or 6A-6C, the processing depicted in FIG. 7 may be performed by a social communication platform or system that facilitates touch communication with users.

At step 705, input data is obtained from a client system of a first user (e.g., captured using one or more sensors). In some instances, the one or more sensors capture input data including images of a visual field of the first user wearing a head-mounted device comprising a display to display content to the first user. The input data includes: (i) data regarding activity of the user in an extended reality environment (e.g., images and audio of the user interacting in the physical environment and/or the virtual environment), (ii) data from external systems, or (iii) both. In some instances, the data regarding activity of the user includes text, audio, images or video, sensor data, or the like.

At step 710, features are extracted from the input data that correspond to an electronic communication. The extracting comprises determining characteristics of the input data and identifying patterns within the input data that correspond to a key or attributes of electronic communication based on the characteristics. The key or attributes are the extracted features.

At step 715, an emoji (e.g., a haptic emoji) is identified from a lexicon of emojis based on the extracted features. The identifying the emoji comprises constructing a query using the extracted features as parameters of the query and executing the query on the lexicon of emojis.

At step 720, digital assets are obtained for the emoji. The digital assets comprise a haptic signal configured with parameter information to generate patterns for haptic output. In some instances, the digital assets further comprise an image or video asset, an audio asset, or both. The haptic signal for the emoji may be pre-generated. In some instances, the haptic signal is configured with the parameter information for interval, pitch, and amplitude to generate the patterns for the haptic output. In some instances, the haptic signal is configured with parameter information for interval, pitch, and amplitude to generate patterns for the haptic output that match the image or animation of the emoji and/or the sound effect of the emoji. In other instances, the haptic signal is configured with parameter information determined by a user (e.g., the first user or another user) to generate patterns for the haptic output that communicate an emotion via touch communication to the second user.

At step 725, the digital assets are transmitted to a device of a second user. In some instances, the device is another head-mounted device. The device is configured to convert the haptic signal to the haptic output based on the parameter information in order to convey a touch message as at least part of the electronic communication to the second user via a haptic device. In some instances, the haptic output is generated with virtual content (e.g., the image or animation of the emoji and/or the sound effect of the emoji) that is generated and rendered by the client system in the extended reality environment displayed to the user based on the digital assets (e.g., the image or video asset, the audio asset, or both).

### Touch Communication Using AI Based System

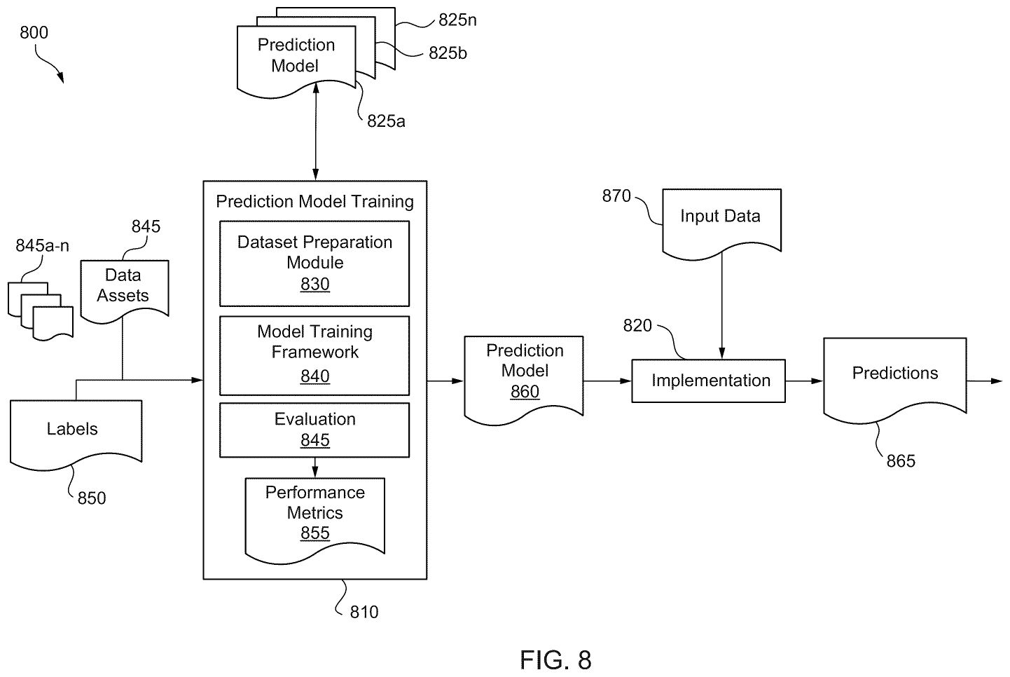

Various embodiments also relate to using artificial intelligence (rule based or machine-learning) to predict haptic emojis for conveying a touch message. FIG. 8 illustrates a machine-learning prediction system 800 in accordance with some embodiments. The machine-learning prediction system 800 may be a component in a signal generator (e.g., signal generator 555 described with respect to FIG. 5). As shown in FIG. 1, the machine-learning prediction system 800 includes various stages: a prediction model training stage 810 to build and train models, an evaluation stage 815 to evaluate performance of trained models, and an implementation stage 820 for implementing one or more models. The prediction model training stage 810 builds and trains one or more prediction models 825a-825n (‘n’ represents any natural number) to be used by the other stages (which may be referred to herein individually as a prediction model 825 or collectively as the prediction models 825). For example, the prediction models 825 can include a model for predicting a haptic emoji from input data, a model for converting input data to a haptic signal for a haptic emoji, and a model for predicting a haptic emoji from a context of a user. Still other types of prediction models may be implemented in other examples according to this disclosure.

A prediction model 825 can be a machine-learning model, such as a convolutional neural network (“CNN”), e.g., an inception neural network, a residual neural network (“Resnet”), or a recurrent neural network, e.g., long short-term memory (“LSTM”) models or gated recurrent units (“GRUs”) models, other variants of Deep Neural Networks (“DNN”) (e.g., a multi-label n-binary DNN classifier or multi-class DNN classifier). A prediction model 125 can also be any other suitable ML model trained for providing a recommendation, such as a Generative adversarial network (GAN), Naive Bayes Classifier, Linear Classifier, Support Vector Machine, Bagging Models such as Random Forest Model, Boosting Models, Shallow Neural Networks, or combinations of one or more of such techniques—e.g., CNN-HMM or MCNN (Multi-Scale Convolutional Neural Network). The machine-learning prediction system 800 may employ the same type of prediction model or different types of prediction models for predicting haptic emojis for conveying a touch message. Still other types of prediction models may be implemented in other examples according to this disclosure.

To train the various prediction models 825, the training stage 810 is comprised of two main components: dataset preparation module 830 and model training framework 840. The dataset preparation module 830 performs the processes of loading data assets 845, splitting the data assets 845 into training and validation sets 845 a-n so that the system can train and test the prediction models 825, and pre-processing of data assets 845. The splitting the data assets 845 into training and validation sets 845 a-n may be performed randomly (e.g., a 90/10% or 70/30%) or the splitting may be performed in accordance with a more complex validation technique such as K-Fold Cross-Validation, Leave-one-out Cross-Validation, Leave-one-group-out Cross-Validation, Nested Cross-Validation, or the like to minimize sampling bias and overfitting.

The training data 845a may include at least a subset of historical input data (e.g., a gesture by a first user) or context data (e.g., a text message received by a second user) received via a client system (e.g., an HMD). The historical input data or context data can be obtained in various ways including text, audio, images or video, sensor data, or the like. For example, if the historical input data or context data is provided as images, the data preparation 830 may convert the images to text using an image-to-text converter (not shown) that performs text recognition (e.g., optical character recognition) to determine the text within the image. Additionally or alternatively, the data preparation module 830 may standardize the format of the historical input data or context data. In some instances, the historical input data or context data is provided by the second user or a third party. The training data 845a for a prediction model 825 may include the historical input data or context data and labels 850 corresponding to the historical input data or context data as a matrix or table of values. For example, for each example of historical input data or context data, an associated haptic emoji or haptic signal to be inferred by the prediction model 825 may be provided as ground truth information for labels 850. The behavior of the prediction model 825 can then be adapted (e.g., through MinMax or Alternating Least Square optimization or Gradient Descent) to minimize the difference between the generated inferences for various entities and the ground truth information.

The model training framework 840 performs the processes of determining hyperparameters for the model 825 and performing iterative operations of inputting examples from the training data 845a into the model 825 to find a set of model parameters (e.g., weights and/or biases) that minimizes a cost function(s) such as loss or error function for the model 825. The hyperparameters are settings that can be tuned or optimized to control the behavior of the model 825. Most models explicitly define hyperparameters that control different features of the models such as memory or cost of execution. However, additional hyperparameters may be defined to adapt the model 825 to a specific scenario. For example, the hyperparameters may include regularization weight or strength. The cost function can be constructed to measure the difference between the outputs inferred using the models 845 and the ground truth annotated to the samples using the labels. For example, for a supervised learning-based model, the goal of the training is to learn a function “h( )” (also sometimes referred to as the hypothesis function) that maps the training input space X to the target value space Y, h: X→Y, such that h(x) is a good predictor for the corresponding value of y. Various different techniques may be used to learn this hypothesis function. In some techniques, as part of deriving the hypothesis function, the cost or loss function may be defined that measures the difference between the ground truth value for an input and the predicted value for that input. As part of training, techniques such as back propagation, random feedback, Direct Feedback Alignment (DFA), Indirect Feedback Alignment (IFA), Hebbian learning, and the like are used to minimize this cost or loss function.

Once the set of model parameters are identified, the model 825 has been trained and the model training framework 840 performs the additional processes of testing or validation using the subset of testing data 845b (testing or validation data set). The testing or validation processes includes iterative operations of inputting examples from the subset of testing data 845b into the model 825 using a validation technique such as K-Fold Cross-Validation, Leave-one-out Cross-Validation, Leave-one-group-out Cross-Validation, Nested Cross-Validation, or the like to tune the hyperparameters and ultimately find the optimal set of hyperparameters. Once the optimal set of hyperparameters are obtained, a reserved test set from the subset of test data 845a may be input into the model 825 to obtain output (in this example, one or more recognized entities), and the output is evaluated versus ground truth entities using correlation techniques such as Bland-Altman method and the Spearman's rank correlation coefficients. Further, performance metrics 855 may be calculated in evaluation stage 815 such as the error, accuracy, precision, recall, receiver operating characteristic curve (ROC), etc. The metrics 855 may be used in the evaluation stage 815 to analyze performance of the model 825 for providing haptic emoji or haptic signal predictions.

The model training stage 810 outputs trained models including one or more trained prediction models 860. The one or more trained prediction models 855 may be deployed and used in the implementation stage 820 to predict a haptic emoji or haptic signal 865 for conveying a touch message. For example, prediction models 860 may receive input data 870 (e.g., a gesture by a first user) or context data (e.g., a text message received by a second user), and predict a haptic emoji or haptic signal based on features and relationships between features extracted from within the input data 870.

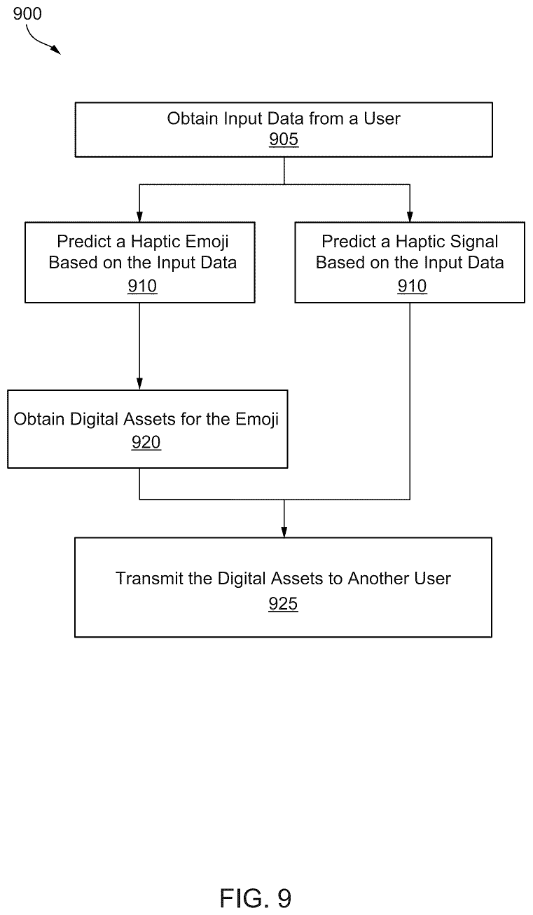

FIG. 9 is a flowchart illustrating a process 900 to predict haptic emojis for conveying a touch message according to various embodiments. The processing depicted in FIG. 9 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 9 and described below is intended to be illustrative and non-limiting. Although FIG. 9 depicts the various processing steps occurring in a particular sequence or order, this is not intended to be limiting. In certain alternative embodiments, the steps may be performed in some different order or some steps may also be performed in parallel. In certain embodiments, such as in an embodiment depicted in FIG. 1, 2A, 2B, 3A, 3B, 4A, 4B, 4C, 5, or 8, the processing depicted in FIG. 9 may be performed by a social communication platform or system that facilitates touch communication with users.

At step 905, input data is obtained from a client system of a first user (e.g., captured using one or more sensors). In some instances, the one or more sensors capture input data including images of a visual field of the first user wearing a head-mounted device comprising a display to display content to the first user. The input data includes: (i) data regarding activity of the user in an extended reality environment (e.g., images and audio of the user interacting in the physical environment and/or the virtual environment), (ii) data from external systems, or (iii) both. In some instances, the data regarding activity of the user includes text, audio, images or video, sensor data, or the like.

At step 910, predicting a haptic emoji or a haptic signal based on the input data and model parameters learned from historical input data (e.g., a gesture by a first user) and context data (e.g., a text message received by a second user).

In instances of predicting a haptic emoji, the predicting comprises inputting the input data into a machine-learning model comprising the model parameters. The machine-learning model may be trained to solve to a multi-classification problem where a class label (e.g., a haptic emoji) is predicted for a given example of the input data. In a multi-classification problem, a number of training examples divided into K separate classes are presented to a machine-learning algorithm, and the machine-learning algorithm is trained to predict which of those classes some previously unseen data belongs to (e.g., a haptic emoji type such as a wave emoji from the previous example). In seeing the training dataset, the machine-learning algorithm learns patterns specific to each class, updates the model parameters in accordance with the learned patterns to generate a machine-learning model, and the machine-learning model uses those learned patterns and model parameters to predict the membership of future input data. For instance, images of user performing a gesture for a haptic emoji may follow a distinct pattern of finger and/or hand positions, helping the machine-learning model to identify future images of gestures for a haptic emoji as compared to random hand or finger movement not associated with a haptic emoji.

In instances of predicting a haptic signal, the predicting comprises inputting the input data into a machine-learning model comprising the model parameters. The machine-learning model may be trained in order to receive as input a pre-processed signal (e.g., an acoustic signal) and generate as output a sequence of haptic signals representing the pre-processed signal. In certain instances, the machine-learning model is a neural network such as a convolutional neural network. The neural network processes on multiple slices (or frames) of a signal representation (e.g., a spectrogram) of the pre-processed signal in order to generate a sequence of haptic signals. The haptic signals may be intended to be a representation of the center slice among the multiple slices that are processed. In certain instances, the machine-learning model is a neural network such as a recurrent neural network, which has nodes that form a directed cycle. In this fashion, the neural network may process each slice of the signal representation separately, but with each slice influencing the state of the neural network for the processing of the subsequent slice. The neural network may use any one of a common set of activation functions, such as the sigmoid, softmax, rectifier, or hyperbolic tangent. The input features are fed into the neural network, which has been initialized with randomized weights or model parameters. The output of the neural network indicates a combination of haptic cues for each slice of the input data that in combination form a haptic signal. Each of these haptic cues indicates the haptic output for a cutaneous actuator and may be represented by one or more nodes in the final layer of the neural network. Each node of the neural network may indicate for each cutaneous actuator, a percentage value that may be used to determine whether to activate a particular state of the cutaneous actuator. For example, if the percentage is below 50%, then the cutaneous actuator should not be activated. Multiple nodes may be used if the cutaneous actuator has more than two states.

At optional step 915 (instances of predicting a haptic emoji), digital assets are obtained for the emoji. The digital assets comprise a haptic signal configured with parameter information to generate patterns for haptic output. In some instances, the digital assets further comprise an image or video asset, an audio asset, or both. The haptic signal for the emoji may be pre-generated. In some instances, the haptic signal is configured with the parameter information for interval, pitch, and amplitude to generate the patterns for the haptic output. In some instances, the haptic signal is configured with parameter information for interval, pitch, and amplitude to generate patterns for the haptic output that match the image or animation of the emoji and/or the sound effect of the emoji. In other instances, the haptic signal is configured with parameter information determined by a user (e.g., the first user or another user) to generate patterns for the haptic output that communicate an emotion via touch communication to the second user.

At step 920, the digital assets or haptic signal are transmitted to a device of a second user. In some instances, the device is another head-mounted device. The device is configured to convert the haptic signal to the haptic output based on the parameter information in order to convey a touch message as at least part of the electronic communication to the second user via a haptic device. In some instances, the haptic output is generated with virtual content (e.g., the image or animation of the emoji and/or the sound effect of the emoji) that is generated and rendered by the client system in the extended reality environment displayed to the user based on the digital assets (e.g., the image or video asset, the audio asset, or both).

### Learning Program to Facilitate Learning of the Haptic Output

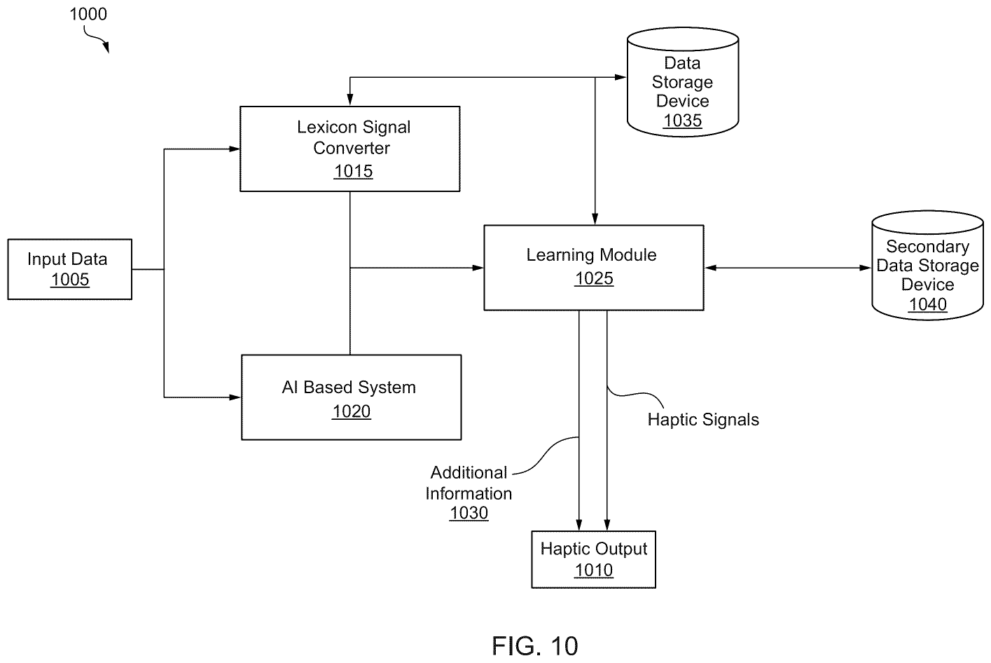

FIG. 10 is a block diagram illustrating components of a social communication system 1000 for supplementing a haptic signal with additional information to facilitate a user learning a haptic output in accordance with various embodiments. To generate the haptic output 1010, input data 1005 from a first user (sending user) is processed by a lexicon signal converter 1015 using a lexicon of emojis (as described in detailed with respect to FIGS. 6A-6C and 7) or an artificial intelligence based system 1020 (as described in detail with respect to FIGS. 8 and 9) to obtain a corresponding haptic signal. A learning module 1025 (e.g., the learning module 567 described with respect to FIG. 5) takes as input the haptic signal (or corresponding haptic emoji information) and determines additional information 1030 (e.g., an audio component or an image component) that could be used to supplement the haptic signal to facilitate a user learning a haptic output in accordance with various embodiments. The haptic signal and additional information are then transmitted to a second user (receiving user) to operate the haptic feedback device and facilitate learning of the haptic output. The haptic feedback device receives the transmitted haptic signals and additional information, translates the haptic signals into the haptic output 1010, translates the additional information into supplemental content (e.g., virtual content), and transmits the haptic output 1010 corresponding to the received haptic signals to a body of the second user and executes the supplemental content (e.g., displays text, renders an image or video, or plays an audible sound).

The input data 1005 may be text, audio, images or video, sensor data, or the like. The additional information 1030 may include a text description of the touch communication conveyed by the haptic signal (e.g., for a wave haptic signal, the text could say “sending user” waves hello to “receiving user”), an audio component corresponding to a haptic signal (e.g., a laughing sound corresponding to a HaHaHa haptic signal), an image component corresponding to a haptic signal (e.g., a character giving a thumbs down for a nope haptic signal), or a combination thereof.

As described previously, a data storage device 1035 (e.g., a lexicon of emojis 615) may comprises any number of emojis. Each of the emojis may be configured with a corresponding electronic communication that includes a visual component (shown in FIG. 6B as the character in each illustration), an audio component (shown in FIG. 6B as the verbal utterance in each illustration), a haptic component (shown in FIG. 6C as the haptic signal pattern in each illustration), or a combination thereof. In such an instance where the lexicon signal converter 1015 converts the input data 1005 into haptic signals 1010 using the data storage device 1035, the learning module 1025 takes as input the haptic signal (or corresponding haptic emoji information) and determines, using one or more rules or logic, additional information 1030 (e.g., an audio component or an image component) that could be used to supplement the haptic signal. For example, a rule or logic may state that if an audio component and/or an image component is associated with the haptic signal (or corresponding haptic emoji information), then retrieve the audio component and/or an image component from the data storage device 1035 and forward along with the haptic component. Alternatively, a rule or logic may state that if an audio component and/or an image component is associated with the haptic signal (or corresponding haptic emoji information) and the second user (receiving user) has never been sent this haptic signal (or has been sent the haptic signal a number of times that is less than a predetermined threshold), then the retrieve the audio component and/or an image component from the data storage device 1035 and forward along with the haptic component.

In other instances where an audio component and/or an image component is or is not associated with the haptic signal in the data storage device 1035, the learning module 1025 takes as input the haptic signal (or corresponding haptic emoji information) and determines, using one or more rules, logic, or machine-learning models, additional information 1030 that could be used to supplement the haptic signal. For example, the learning module 1025 may use a machine-learning model to infer additional information 1030 (e.g., a text component, an image component, an audio component, or a combination hereof)) that could be used to supplement the haptic signal (or corresponding haptic emoji information), then retrieve the additional information 1030 from a secondary data storage device 1040 (e.g., a remote storage device or third-party storage device) and forward along with the haptic component. Alternatively, the learning module 1025 may use a decision tree to identify additional information 1030 that could be used to supplement the haptic signal (or corresponding haptic emoji information), then retrieve the additional information 1030 from a secondary data storage device 1040 (e.g., a remote storage device or third-party storage device) and forward along with the haptic component. As should be understood, more complex logic could be executed by the learning module 1025 using various combinations, such as—the learning module 1025 may use a machine-learning model to infer additional information 1030 that could be used to supplement the haptic signal (or corresponding haptic emoji information) and execute a rule or logic that states if the additional information 1030 is available and the second user (receiving user) has never been sent this haptic signal (or has been sent the haptic signal a number of times that is less than a predetermined threshold), then the retrieve the additional information 1030 from secondary data storage device 1040 and forward along with the haptic component.

In other instances, where the artificial intelligence based system 1020 predicts a haptic emoji or haptic signal, the learning module 1025 takes as input the haptic signal (or corresponding haptic emoji information) and determines, using one or more rules, logic, or machine-learning models, additional information 1030 (e.g., an audio component or an image component) that could be used to supplement the haptic signal. For example, the learning module 1025 may use one or more rules, logic, or machine-learning models to determine a text component, an audio component and/or an image component that could be used to supplement the haptic signal (or corresponding haptic emoji information), then retrieve the text component, the audio component and/or the image component from the data storage device 1035 or a secondary data storage device 1040 (e.g., a remote storage device or third-party storage device) and forward along with the haptic component.

The benefits and advantages of this approach are that the receiving user may more easily learn the haptic output patterns and associated meaning based on associated visual and/or audio context. For example, the learning module 1025 may be configured to transmit the haptic signal along with a visual and/or audio signal to the receiving user such that when the user feels the haptic output 1010 based on the haptic signal the user concurrently visualizes on a display the visual signal (e.g., a visual emoji) and/or hears the audio signal, the user learns to associate the haptic output pattern with an associated visual and/or audio context. The visual and/or audio signal may be obtained as part of the additional information 1030 and associated and transmitted with the haptic signal by the learning module 1025. Additionally or alternatively, the visual and/or audio signal may be generated based on the additional information 1030 by the learning module 1025, and associated and transmitted with the haptic signal by the learning module 1025.

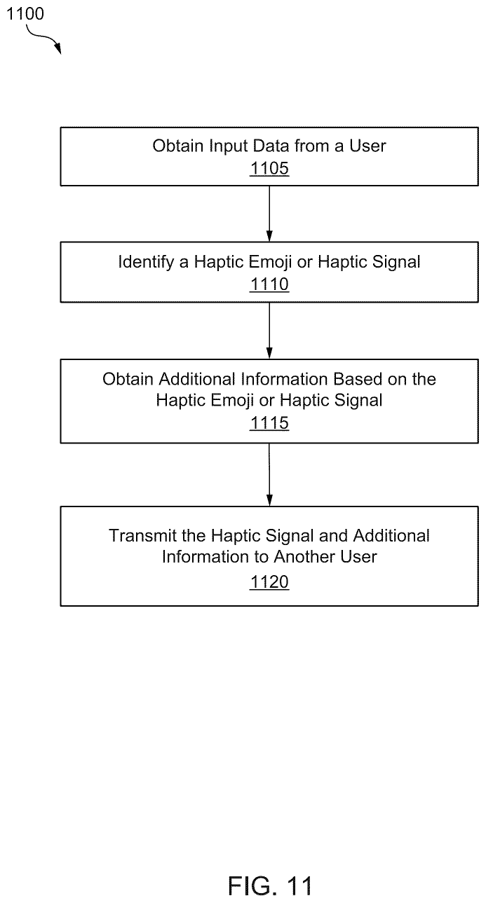

FIG. 11 is a flowchart illustrating a process 1100 for supplementing a haptic signal with additional information to facilitate a user learning a haptic output in accordance with various embodiments. The processing depicted in FIG. 11 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 11 and described below is intended to be illustrative and non-limiting. Although FIG. 11 depicts the various processing steps occurring in a particular sequence or order, this is not intended to be limiting. In certain alternative embodiments, the steps may be performed in some different order, or some steps may also be performed in parallel. In certain embodiments, such as in an embodiment depicted in FIG. 1, 2A, 2B, 3A, 3B, 4A, 4B, 4C, 5, 6A-6C, 8, or 10 the processing depicted in FIG. 11 may be performed by a social communication platform or system that facilitates touch communication with users.

At step 1105, input data is obtained from a client system of a first user (e.g., captured using one or more sensors). In some instances, the one or more sensors capture input data including images of a visual field of the first user wearing a head-mounted device comprising a display to display content to the first user. The input data includes: (i) data regarding activity of the user in an extended reality environment (e.g., images and audio of the user interacting in the physical environment and/or the virtual environment), (ii) data from external systems, or (iii) both. In some instances, the data regarding activity of the user includes text, audio, images or video, sensor data, or the like.

At step 1110, an emoji (e.g., a haptic emoji) or haptic signal is identified from a lexicon of emojis or an artificial intelligence based system, as described with respect to FIGS. 6A-6C, 7, 8, and 9.

At step 1115, additional information is obtained based on the emoji or haptic signal. The additional information may include a text description of the touch communication conveyed by the haptic signal (e.g., for a wave haptic signal, the text could say “sending user” waves hello to “receiving user”), an audio component corresponding to a haptic signal (e.g., a laughing sound corresponding to a HaHaHa haptic signal), an image component corresponding to a haptic signal (e.g., a character giving a thumbs down for a nope haptic signal), or a combination thereof.

At step 1120, the haptic signal and additional information are transmitted to a device of a second user. In some instances, the device is another head-mounted device. The device is configured to convert the haptic signal to the haptic output based on the parameter information in order to convey a touch message as at least part of the electronic communication to the second user via a haptic device. The haptic output is generated with virtual content (e.g., the image or animation of the emoji and/or the sound effect of the emoji), which is generated and rendered by the client system in the extended reality environment displayed to the user based on the additional information (e.g., the text, the image or video, the audio, or any combination thereof).

### Receiving the Haptic Signal and Generating the Haptic Output

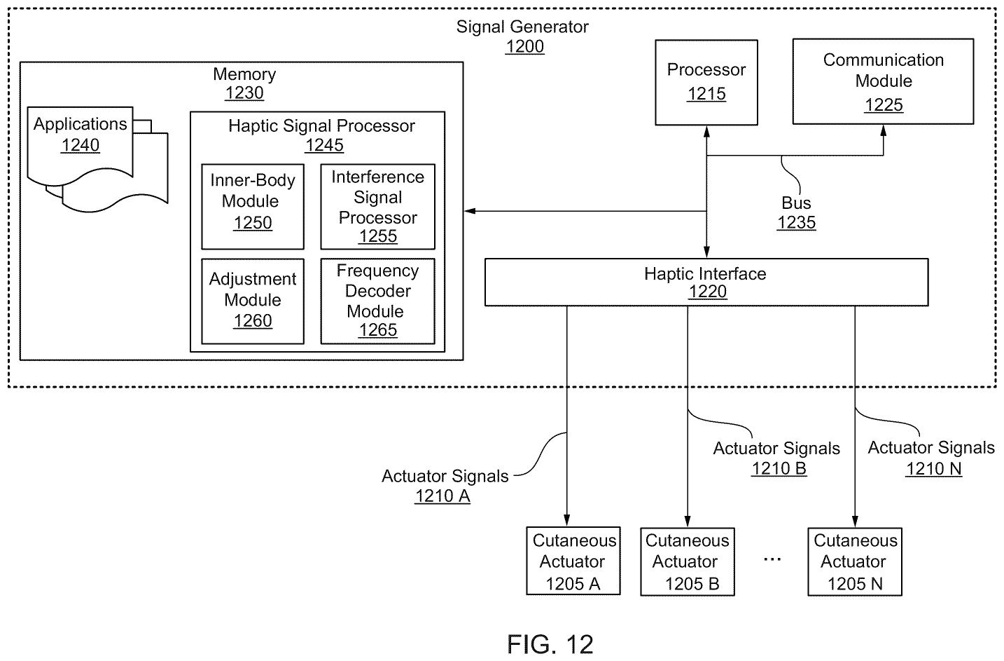

FIG. 12 is a block diagram illustrating a signal generator 1200 for operating cutaneous actuators 1205A through 1205N (hereinafter collectively referred to as “cutaneous actuators 1205”) to deliver haptic output (tactile feedback) to a user according to various embodiments. The signal generator 1200 may be part of a client system or can be a stand-alone device that generates actuator signals 1210A through 1210N (hereinafter collectively referred to as “actuator signals 1210”) for transmitting to the cutaneous actuators 1205. When the signal generator 1200 is part of the client system, the signal generator 1200 communicates with other computing devices such as another client device or other computing devices to receive the haptic signal. The signal generator 1200 may include, among other components, a processor 1215, a haptic interface circuit 1220, a communication module 1225, memory 1230 and a bus 1235 connecting these components. The signal generator 1200 may include other components not illustrated in FIG. 12 such as user interface modules for interacting with users or speakers. The signal generator 1200 may also be a part of a larger device or an add-on device that expands function of another device.

The processor 1215 reads instructions from the memory 1230 and executes them to perform various operations. The processor 1215 may be embodied using any suitable instruction set architecture and may be configured to execute instructions defined in that instruction set architecture. The processor 1215 may be general-purpose or embedded processors using any of a variety of instruction set architectures (ISAs), such as the x86, PowerPC, SPARC, RISC, ARM or MIPS ISAs, or any other suitable ISA. Although a single processor is illustrated in FIG. 12, the signal generator 1200 may include multiple processors.

The haptic interface circuit 1220 is a circuit that interfaces with the cutaneous actuators 1205. The haptic interface circuit 1220 generates actuator signals 1210 based on commands from the processor 1215. For this purpose, the haptic interface circuit 1220 may include, for example, a digital-to-analog converter (DAC) for converting digital signals into analog signals. The haptic interface circuit 1220 may also include an amplifier to amplify the analog signals for transmitting the actuator signals 1210 over cables between the signal generator 1200 and the cutaneous actuators 1205. In some embodiments, the haptic interface circuit 1220 communicates with the actuators 1205 wirelessly. In such embodiments, the haptic interface circuit 1220 includes components for modulating wireless signals for transmitting to the actuator 1205 over wireless channels.

The communication module 1225 (e.g., receiving device 570 described with respect to FIG. 5) is hardware or combinations of hardware, firmware and software for communicating with other computing devices. The communication module 1225 may, for example, enable the signal generator 1200 to communicate with a social networking system, a transmitting or sending client system, or an electronic communication source over the network. The communication module 1225 may be embodied as a network card. The memory 1230 is a non-transitory computer readable storage medium for storing software modules. Software modules stored in the memory 1230 may include, among others, applications 1240 and a haptic signal processor 1245 (e.g., the signal processor 547 described with respect to FIG. 5). The memory 1230 may include other software modules not illustrated in FIG. 8, such as an operating system. The applications 1240 may use haptic output via the cutaneous actuators 1205 to perform various functions, such as electronic communication, gaming, and entertainment.

The haptic signal processor 1245 is a module that determines the actuator signals 1210 to be generated by the haptic interface circuit 1220. The haptic signal processor 1245 generates digital versions of the actuator signals and sends to the haptic interface circuit 1220 via bus 1235. A digital version of the actuator signals includes information defining the analog actuator signals to be generated by the haptic interface circuit 1220. For example, the digital version of the actuator signals may indicate, for example, the amplitude or frequency of the analog actuator signals, time at which the actuator signals are to be transmitted by the haptic interface circuit 1220, and waveform of the actuator signals. The haptic signal processor 1245 receives commands including the haptic signal from the applications 1240 and/or other computing devices such as another client device or other computing devices and determines parameters associated with the actuator signal 1210. The parameters of the actuator signal 1210 may include, among others, timing gap between activation of the actuator signals, duration of the actuator signals, the amplitude of the actuator signals, the waveform of the actuator signals, which actuator signals to become active, and modes of cutaneous actuators (if the cutaneous actuators have more than one mode of operation).

The haptic signal processor 1245 may include sub-modules such as an inner-body module 1250, an interference signal processor 1255, an adjustment module 1260, and a frequency decoder module 1265. The inner-body module 1250 may be invoked to generate actuator signals 1210 that cause the cutaneous actuators to generate the sensation or illusion of motions or actions occurring inside the body. The interference signal processor 1255 may be invoked for generating actuator signals 1210 that causes cutaneous actuators to generate vibrations that result in constructive or destructive interference on the receiving user's skin. The adjustment module 1260 may be invoked to modify a haptic signal based on user preferences (e.g., no haptic output with an amplitude or duration over a predetermined threshold) for generating actuator signals 1210. The frequency decoder module 1265 may be invoked for generating actuator signals 1210 in an operating mode where a haptic signal is encoded using a frequency decomposition scheme. As should be understood, the haptic signal processor 1245 may include other modules for operating the cutaneous actuators to operate in different modes or perform additional or alternative functionality. For example, a mimic signal processor may be invoked for generating actuator signals that causes haptic output to mimic actual touch on a user's body.

The signal generator 1200 as illustrated in FIG. 12 is merely illustrative and various modification may be made to the signal generator 1200. For example, instead of embodying the signal generator 1200 as a software module, the signal generator 1200 may be embodied as a hardware circuit, or a combination of hardware circuits and software modules.

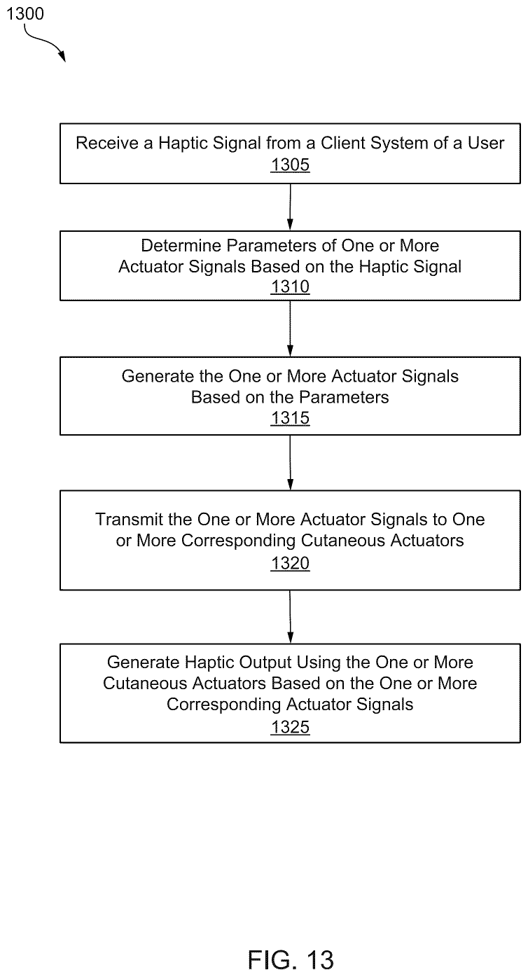

FIG. 13 is a flowchart illustrating a process 1300 for generating a haptic output in accordance with various embodiments. The processing depicted in FIG. 13 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 13 and described below is intended to be illustrative and non-limiting. Although FIG. 13 depicts the various processing steps occurring in a particular sequence or order, this is not intended to be limiting. In certain alternative embodiments, the steps may be performed in some different order, or some steps may also be performed in parallel. In certain embodiments, such as in an embodiment depicted in FIG. 1, 2A, 2B, 3A, 3B, 4A, 4B, 4C, 5, 6A-6C, 8, 10, or 12 the processing depicted in FIG. 13 may be performed by a social communication platform or system that facilitates touch communication with users.

At step 1305, a haptic signal (and optionally additional information) is received by a first client system (e.g., a client system comprising a head-mounted device) of a first user. The haptic signal (and optionally additional information) is generated by a second client system of a second user (sending user) in accordance with the description of FIGS. 5, 6A-6C, and 7-11. The haptic signal is configured with parameter information on interval, pitch, amplitude, or a combination thereof for a touch message to be perceived by the first user's body. These parameters are used to generate haptic outputs corresponding to the parameters. For example, the parameters of the haptic signal may be translated into a duration time, frequency, or amplitude of the haptic outputs. The additional information may include a text description of the touch communication conveyed by the haptic signal (e.g., for a wave haptic signal, the text could say “sending user” waves hello to “receiving user”), an audio component corresponding to a haptic signal (e.g., a laughing sound corresponding to a HaHaHa haptic signal), an image component corresponding to a haptic signal (e.g., a character giving a thumbs down for a nope haptic signal), or a combination thereof.

At step 1310, parameters of one or more actuator signals are determined based on the haptic signal. The parameters of the actuator signals may include information on pressure, temperature, texture, sheer stress, time, space, or a combination thereof of a physical touch perceivable by the first user's body. These parameters (e.g., pressure) may be used by one or more cutaneous actuators to generate haptic outputs corresponding to the parameters received by the one or more cutaneous actuators. For example, the parameters may be translated into a duration time, frequency, or amplitude of the haptic outputs. In some instances, the haptic signal or the one or more actuator signals is adjusted based on preferences of the second user. For example, the parameter information on pressure, temperature, texture, sheer stress, time, space, interval, pitch, amplitude, or a combination thereof for the one or more actuator signals may be adjusted in accordance with the preferences of the second user. Alternatively, the parameter information on the interval, pitch, amplitude, or a combination thereof for the haptic signal may be adjusted in accordance with the preferences of the second user. In some instances, the parameters information is adjusted such that the duration time, frequency, amplitude, or a combination thereof of the haptic outputs is limited or maintained in accordance with one or more predetermined thresholds (e.g., a user's sensory threshold, configuration of the cutaneous actuators, and/or user's preferences or settings). In some instances, the parameters information is adjusted such that the haptic output is personalized to enhance training and/or understanding of the haptics (e.g., touch communication).

At step 1315, the one or more actuator signals are generated based on the parameters determined for the one or more actuator signals. The generating of the one or more actuator signals may include performing digital to analog conversion of the haptic signal and/or one or more actuator signals.

At step 1320, the one or more actuator signals are transmitted to one or more corresponding cutaneous actuators.

At step 1325, one or more cutaneous actuators generate haptic output in accordance with the corresponding one or more actuator signals, which cause one or more of various types of cutaneous feedback, including vibration, force, traction, texture, and/or temperature on the second user's body. In some instances, the haptic output is generated with virtual content (e.g., the image or animation of the emoji and/or the sound effect of the emoji), which is generated and rendered by the client system in the extended reality environment displayed to the user based on the additional information (e.g., the text, the image or video, the audio, or any combination thereof).

### ADDITIONAL CONSIDERATIONS

Although specific examples have been described, various modifications, alterations, alternative constructions, and equivalents are possible. Examples are not restricted to operation within certain specific data processing environments, but are free to operate within a plurality of data processing environments. Additionally, although certain examples have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described examples may be used individually or jointly.

Further, while certain examples have been described using a particular combination of hardware and software, it should be recognized that other combinations of hardware and software are also possible. Certain examples may be implemented only in hardware, or only in software, or using combinations thereof. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the examples. However, examples may be practiced without these specific details. For example, well-known circuits, processes, algorithms, structures, and techniques have been shown without unnecessary detail in order to avoid obscuring the examples. This description provides example examples only, and is not intended to limit the scope, applicability, or configuration of other examples. Rather, the preceding description of the examples will provide those skilled in the art with an enabling description for implementing various examples. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific examples have been described, these are not intended to be limiting. Various modifications and equivalents are within the scope of the following claims.

In the foregoing specification, aspects of the disclosure are described with reference to specific examples thereof, but those skilled in the art will recognize that the disclosure is not limited thereto. Various features and aspects of the above-described disclosure may be used individually or jointly. Further, examples may be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate examples, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Where components are described as being configured to perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

While illustrative examples of the application have been described in detail herein, it is to be understood that the inventive concepts may be otherwise variously embodied and employed, and that the appended claims are intended to be construed to include such variations, except as limited by the prior art.

What is claimed is:

1. An extended reality system comprising:
a head-mounted device comprising a display to display content to a first user, one or more sensors to capture input data including images of a visual field of the first user;
one or more processors; and
one or more memories accessible to the one or more processors, the one or more memories storing a plurality of instructions executable by the one or more processors, the plurality of instructions comprising instructions that when executed by the one or more processors cause the one or more processors to perform processing comprising:
capturing, using the one or more sensors, the input data from the first user;
extracting features from the input data that correspond to an electronic communication;
identifying an emoji from a lexicon of emojis based on the extracted features;
obtaining digital assets for the emoji, wherein the digital assets comprise a haptic signal configured with parameter information to generate patterns for haptic output; and
transmitting the digital assets to a device of a second user.

2. The extended reality system of claim 1, wherein the extracting the features comprises:
determining characteristics of the input data, and
identifying patterns within the input data that correspond to a key or attributes of electronic communication based on the characteristics, the key or attributes being the extracted features; and
wherein the identifying the emoji comprises:
constructing a query using the extracted features as parameters of the query, and
executing the query on the lexicon of emojis.

3. The extended reality system of claim 1, wherein the haptic signal is configured with the parameter information for interval, pitch, and amplitude to generate the patterns for the haptic output.

4. The extended reality system of claim 1, wherein the digital assets further comprise an image or video asset, an audio asset, or both.

5. The extended reality system of claim 1, wherein the processing further comprises obtaining additional information based on the emoji or the haptic signal, the additional information includes a text description of the haptic output conveyed by the haptic signal, an audio component corresponding to the haptic signal, an image component corresponding to the haptic signal, or a combination thereof, and transmitting the additional information to the device of the second user.

6. An extended reality system comprising:
a head-mounted device comprising a display to display content to a first user, one or more sensors to capture input data including images of a visual field of the first user;
one or more processors; and
one or more memories accessible to the one or more processors, the one or more memories storing a plurality of instructions executable by the one or more processors, the plurality of instructions comprising instructions that when executed by the one or more processors cause the one or more processors to perform processing comprising:
capturing, using the one or more sensors, the input data from the first user;
predicting a haptic emoji or a haptic signal based on the input data and model parameters learned from historical input data and context data; and
transmitting the haptic signal or digital assets for the haptic emoji to a device of a second user.

7. The extended reality system of claim 6, wherein the processing further comprises obtaining the digital assets for the haptic emoji, and the digital assets comprise the haptic signal configured with parameter information to generate patterns for haptic output.

8. The extended reality system of claim 6, wherein the haptic signal is configured with the parameter information for interval, pitch, and amplitude to generate the patterns for the haptic output.

9. The extended reality system of claim 6, wherein the digital assets further comprise an image or video asset, an audio asset, or both.

10. The extended reality system of claim 7, wherein the processing further comprises obtaining additional information based on the emoji or the haptic signal, the additional information includes a text description of the haptic output conveyed by the haptic signal, an audio component corresponding to the haptic signal, an image component corresponding to the haptic signal, or a combination thereof, and transmitting the additional information to the device of the second user.

11. An extended reality system comprising:
a head-mounted device comprising a display to display content to a first user, one or more sensors to capture input data including images of a visual field of the first user;
one or more processors; and
one or more memories accessible to the one or more processors, the one or more memories storing a plurality of instructions executable by the one or more processors, the plurality of instructions comprising instructions that when executed by the one or more processors cause the one or more processors to perform processing comprising:
receiving, at the head-mounted device, a haptic signal from a second user, wherein the haptic signal is configured with parameter information on interval, pitch, amplitude, or a combination thereof for a touch message to be perceived by the first user's body;
determining parameters of one or more actuator signals based on the haptic signal;
generating the one or more actuator signals based on the parameters determined for the one or more actuator signals;
transmitting the one or more actuator signals to one or more corresponding cutaneous actuators; and
generating, by the one or more cutaneous actuators, haptic output in accordance with the corresponding one or more actuator signals, wherein the haptic output conveys the touch message to the first user's body.

12. The extended reality system of claim 11, wherein the parameters of the one or more actuator signals include information on pressure, temperature, texture, sheer stress, time, space, or a combination thereof.

13. The extended reality system of claim 11, wherein the processing further comprises prior to generating the one or more actuator signals, adjusting the parameter information on the interval, pitch, amplitude, or a combination thereof for the haptic signal in accordance with preferences of the first user.

14. The extended reality system of claim 12, wherein the processing further comprises prior to generating the one or more actuator signals, adjusting the parameter information on the pressure, temperature, texture, sheer stress, time, space, or a combination thereof for the one or more actuator signals in accordance with preferences of the first user.

15. The extended reality system of claim 11, wherein the processing further comprises obtaining additional information based on an emoji or the haptic signal, the additional information includes a text description of the haptic output conveyed by the haptic signal, an audio component corresponding to the haptic signal, an image component corresponding to the haptic signal, or a combination thereof, and the haptic output is generated with virtual content, which is generated and rendered by the head-mounted device in an extended reality environment displayed to the first user based on the additional information.

16. The extended reality system of claim 11, wherein the haptic signal is predicted based on input data and model parameters learned from historical input data and context data, and the input data is captured from a head-mounted device of the second user.

17. The extended reality system of claim 11, wherein the haptic signal is part of digital assets obtained for an emoji identified from a lexicon of emojis.

18. The extended reality system of claim 17, wherein the emoji is identified from a lexicon of emojis based on extracted features from input data that correspond to an electronic communication, and the input data is captured from a head-mounted device of a second user.

19. The extended reality system of claim 17, wherein the digital assets further comprise an image or video asset, an audio asset, or both.

20. The extended reality system of claim 17, wherein the haptic signal for the emoji is transmitted to the head-mounted device of the first user.
